(19) United States
(12) Patent Application Publication
(10) Pub. No.: US 2004/0168109 A1
(43) Pub. Date: Aug. 26, 2004

(54) Efficient remote management of devices by accurately removing abnormal condition reports

(76) Inventor: Masaaki Ogura, Kawasaki-shi (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/762,994

(22) Filed: Jan. 22, 2004

(30) Foreign Application Priority Data
Jan. 24, 2003 (JP) 2003-016407

(51) Int. Cl. H02H 3/05

(52) U.S. Cl. 714/47

(57) ABSTRACT

The remote management is efficient for maintaining the condition of a plurality of devices. When the communication device in the remote device transmits the information on a detected abnormal condition to a management device, the management device stores and manages the abnormal condition information until the abnormal condition is processed at the management device location to resolve the corresponding problem. To solve the problem, an operator at the management device site often gets involved in the process. Unfortunately, the operator wastes his or her effort to solve the problem that has been already resolved by the user. One exemplary situation of the above described case is that the user resets certain reported problem in an image forming machine such as a copier by temporarily switching off the copier. The remote management takes care of the above self corrected situations by accurately keeping track of the reported problems base upon the abnormal condition report, the power activation report, the abnormal condition removal report and first and second predetermined amounts of time for specifying the receipt timing of some reports.

### FIELD OF INVENTION

The current invention is generally related to a computer program and a communication device and more particularly related to a remote management system via network for communication devices, a method of controlling the communication devices and a computer program controlling the above system.

### BACKGROUND OF INVENTION

A remote management system was proposed in the past that a remote management device at a service center remotely controls managed devices via networks such as the Internet and public lines. The managed devices includes electronic devices with measuring units and communication units. The measuring units are applicable to the water, electricity and gas consumption, air conditioning units, electrical power supply units, medical devices, automatic vending machines, the network-based consumer electronics as well as the image processing devices. Certain image processing devices includes multi-functional digital devices, scanners, digital copies, facsimiles (fax) and printers with communication capability.

On the other hand, if the managed devices do not have communication capability, it has been proposed that an intermediate device with the communication function is connected via network and that a remote management system manages the managed devices via the network and the intermediate device. For example, if the managed device is an image processing device, it is common to use the know photo electro static process for forming an image on regular paper. The photo electro static process has a relatively high incident rate for malfunction. Furthermore, since it is necessary to regularly overhaul for maintaining the performance, service has been adapted for conservative management.

To achieve the conservative management, the remote management system for image forming devices includes a communication unit either inside or outside of the image forming devices. The image forming device is connected to the management device at the service center via public lines such as a telephone line. A product is commercially available for communicating situational information with a management device via a communication unit. Please refer to the following patent disclosures in Japanese Patent Publications 8-314815, 2002-144684, 2001-34122, 2001-109334 and 2001-194964.

The following will describe as to how the above remote management system controls the abnormal occurrence in the image forming apparatus. Referring to FIG. 36, a timing chart illustrate sequences for processing abnormal occurrence in the image forming apparatus according to a prior art remote management system. The chart does not illustrate data transfer paths between the management apparatus 102 and the image forming apparatus 100 as well as the internal processes in the image forming apparatus 100. In the remote management system, the image forming apparatus 100 is equipped with a detection unit for detecting its own abnormal conditions via various sensors. In detecting the abnormal condition at an event A, a corresponding detecting unit detects it as a service man call (SC) and transmits the SC call to the management apparatus 102. In receiving the SC call, the management apparatus 102 stores the information from the SC call and reports to an operator by displaying the information on a terminal monitor in an event B.

In response to the report, the operator at the management apparatus (herein after called center operator) instructs the management apparatus 102 to prepare a status request for obtaining the status information on the image forming apparatus in an event C. The management apparatus 102 correspondingly transmits the status request to the image forming apparatus 100. In response to the request, the image forming apparatus 100 returns the information indicative of its status such as normal or abnormal conditions. The center operator thus knows the image forming apparatus conditions based upon the returned information. In case that the abnormal condition has not returned to normal, the center operator confirms the abnormal conditions with the user or the image forming apparatus user via telephone in an event D. If necessary, the center operator arranges a customer engineer (CE) to be dispatched.

Now referring to FIGS. 37 and 38, timing charts illustrate data flows of the above described process in the communication sequence. FIG. 37 illustrates the data flow when the abnormal condition has not been removed while FIG. 38 illustrates the data flow when the abnormal condition has been removed. Referring now particularly to FIG. 37, the image forming apparatus 100 includes a controller 100A and an abnormal detection unit in the scanner or plotter engine 100B. The abnormal detection unit monitors the engine status, detects an abnormal condition as a SC in an event A and transmits the abnormal information indicative of the SC occurrence to the controller 100A. Upon receiving the SC occurrence from the engine 100B, the controller 100A determines that the SC has occurred in the engine 100B and generates a message for the SC call for an automatic reporting of the SC information in an event B. The controller 100A transmits the generated message to a line adaptor or an intermediate device 101. At this time, the message, “SC Call in progress” is displayed on the character display on the operational unit. In response to the SC call message from the controller 100A, the line adapter 101 reports to the controller 100A the call reception OK and performs the SC call to the management apparatus 102 at the service center via the public line. That is, the SC call information indicative of the SC call is automatically reported to the management apparatus 102 via the public line. The management apparatus 102 at the service center receives the SC call information from the line adapter 101 at the user side or the image forming apparatus user side. Upon completing the normal reception, the management apparatus 102 transmits a call result OK indicative of the successful completion of the process on the SC call to the originating line adaptor 101 via the public circuit.

The received information on the SC call is stored in a queue such as a database on the hard disk and is held there until the center operator processes the information. The received SC call information is displayed on a display unit to report to the center operator. Upon receiving the call result OK from the management apparatus 102 at the service center, the originating line adapter 101 transmits the call result OK to the controller 100A of the image forming apparatus 100. After the controller 100A of the image forming apparatus 100 receives the call result OK from the line adaptor 101, the controller 100A displays the message, “SC call success” on the character display unit of the operational unit.

Still referring to FIG. 37, the center operator confirms the SC occurrence in the originating image forming apparatus engine 100B based upon the display unit of the management apparatus 102, he or she initiates the corresponding tasks. That is, initially, to know the status of the originating image forming apparatus 100 for the SC call, the center operator operates on the management apparatus 102 to transmit to the SC call originating line adapter 101 a status request with the device identifier information. By referring to identifier information that has been added by the line adapter 101, the status request is forwarded to the controller 100A of the SC call originating device. Upon receiving the status request from the line adapter 101, the controller 100A of the image forming apparatus 100 investigates the engine status and transmits the line adapter 101 the status response indicating the investigation result. In this case, the investigation result indicates that the status is under abnormal conditions.

Upon receiving the status response from the image forming apparatus controller 100A, the line adapter 101 transmits the status response to the management apparatus 102 at the service center via public line. After receiving the status response information from the line adaptor 101, the management apparatus 102 at the service center reports to the center operator by displaying the status response information on the display monitor. By looking at the display of the management apparatus 102, the center operator confirms the SC occurrence inside the print engine of the SC call originating image forming apparatus 100. Subsequently, the center operator calls a corresponding user of the image forming apparatus to confirm the abnormal conditions so that the center operator consults the user on the correction of the abnormal conditions. If necessary, the center operator contacts a service station and arranges to dispatch a repair person.

After the abnormal condition has been removed, referring now to FIG. 38, the image forming apparatus 100 includes a controller 100A and an abnormal detection unit in the scanner or plotter engine 100B. The abnormal detection unit monitors the engine status, detects an abnormal condition as a SC in an event A and transmits the abnormal information indicative of the SC occurrence to the controller 100A. Upon receiving the SC occurrence from the engine 100B, the controller 100A determines that the SC has occurred in the engine 100B and generates a message for the SC call for an automatic reporting of the SC information in an event B. The controller 100A transmits the generated message to a line adaptor or an intermediate device 101. At this time, the message, “SC Call in progress” is displayed on the character display on the operational unit. In response to the SC call message from the controller 100A, the line adapter 101 reports to the controller 100A the call reception OK and performs the SC call to the management apparatus 102 at the service center via the public line. That is, the SC call information indicative of the SC call is automatically reported to the management apparatus 102 via the public line. The management apparatus 102 at the service center receives the SC call information from the line adapter 101 at the user side or the image forming apparatus user side. Upon completing the normal reception, the management apparatus 102 transmits a call result OK indicative of the successful completion of the process on the SC call to the originating line adaptor 101 via the public circuit.

The received information on the SC call is stored in a queue such as a database on the hard disk and is held there until the center operator processes the information. The received SC call information is displayed on a display unit to report to the center operator. Upon receiving the call result OK from the management apparatus 102 at the service center, the originating line adapter 101 transmits the call result OK to the controller 100A of the image forming apparatus 100. After the controller 100A of the image forming apparatus 100 receives the call result OK from the line adaptor 101, the controller 100A displays the message, “SC call success” on the character display unit of the operational unit. At this time, since the user or operator knows that the SC status or the abnormality can be reset by temporarily turning the main power supply off and on, the user turns the main power supply in an event E to attempt the reset for correcting the abnormal condition. Because of the above power on or power activation procedure, the information indicative of the SC status removal or a ready signal is transmitted to the controller 100A.

On the other hand, still referring to FIG. 38, the center operator confirms the SC occurrence in the originating image forming apparatus engine 100B based upon the display unit of the management apparatus 102, he or she initiates the corresponding tasks. That is, initially, to know the status of the originating image forming apparatus 100 for the SC call, the center operator operates on the management apparatus 102 to transmit to the SC call originating line adapter 101 a status request with the device identifier information. By referring to identifier information that has been added by the line adapter 101, the status request is forwarded to the controller 100A of the SC call originating engine 100B. Upon receiving the status request from the line adapter 101, the controller 100A of the image forming apparatus 100 investigates the engine status and transmits the line adapter 101 the status response indicating the investigation result. Because of the above described power source deactivation event E and the subsequent ready signal, the controller 100A generates a status response signal indicative or normal. Upon receiving the status response from the image forming apparatus controller 100A, the line adapter 101 transmits the same status response to the management apparatus 102 at the service center via public line. After receiving the status response information from the line adaptor 101, the management apparatus 102 at the service center reports to the center operator by displaying the normal status response information on the display monitor. By looking at the display of the management apparatus 102, the center operator confirms that the SC occurrence has been removed and will not call the users.

Although the center operator manually initiates the transmission of the status request and respond to the status response in the above example, the following patent disclosure in FIG. 4 and paragraph 21 in Japanese Patent Publication 11-331399 disclose an alternative technology. The center operator determines whether or not the abnormal conditions specified by the SC call are to be reset or recovered by a reset signal. For a certain SC call, he sends the reset signal to the image forming apparatus to execute the reset process. After a predetermined amount of time, a status request is automatically sent to the image forming apparatus.

Despite the above disclosed prior art technologies in the remote control systems, the following problems remain for improvement. That is, in case that the managed device or the image forming apparatus experience abnormal conditions, since some of these conditions are reset by the temporary power deactivation, the device users are able to handle the above situations. Even in these situations, the service center personnel is not able to determine the resolution of the abnormal conditions until the status response is returned. In other words, it is necessary that the center operator instructs the transmission of the status requests, refers to the status responses and determines the resolution of the previously existing abnormal conditions. Because of the above outlined process, even though there are certain abnormal conditions that the user takes care of and no needs to interact with the user, the center operator still has to expend some effort to deal with these conditions.

Even if the status requests are automatically made as disclosed by the above discussed Japanese Patent Publication 11-331399, it is not possible to detect the resolution until the status request is returned. For this reason, a problem has remained that the SC call database has not been promptly updated even after the abnormal conditions have been resolved. To solve the above problem, although it has been considered that the status request is frequently performed, it is also problematic to handle an increased amount of communication traffic or associated processing.

In the recent years, it has been attempted to design the management system by connecting the management device and the managed devices over the Internet. In view of the security issues, it is common that the firewalls are installed in the network to which the managed devices are connected at the user side. Because of the installed firewalls, it is substantially limited for the outside management device to access the managed devices inside the firewalls. As a result of the firewall protection, the status request transmission is not easily accomplished. To reach from the management device to the managed device over the firewall protection, one transmission method is to have a hyper text transfer protocol (HTTP) session from the managed apparatus to the management apparatus to establish a communication path via a communication request. Although as a response, necessary information is transmitted via the HTTP session, because it is necessary to wait for the polling by the managed apparatus, the status request is not always transmitted.

It is desired that the effort to handle abnormal conditions is minimized by accurately placing in the management apparatus the abnormal conditions of the managed apparatus and deleting them from the management apparatus. The management apparatus remotely manages the managed apparatus such as a communication device of the image forming apparatus via network. It is also desired to communicate between the managed and management devices even if the firewalls are installed.

### SUMMARY OF THE INVENTION

In order to solve the above and other problems, according to a first aspect of the current invention, a method of communicating, including the steps of: detecting one of a predetermined set of abnormal conditions at a plurality of managed devices; transmitting abnormal condition information on the detected abnormal condition from the managed device to the management device; receiving the abnormal condition information at the management device to store and manage the received abnormal condition information; detecting removal of the previously detected abnormal condition from a corresponding one of the managed devices, the corresponding managed device defining an originating managed device; transmitting from the managed device to the management device an abnormal condition removal call corresponding to the previously detected abnormal condition; receiving the abnormal condition removal call at the management device; and deleting a corresponding one of the abnormal condition information stored at the management device based upon the received abnormal condition removal call.

According to the second aspect of the current invention, a software program containing computer readable instructions for performing the tasks of communicating, the instructions performing the tasks of detecting one of a predetermined set of abnormal conditions at a plurality of managed devices; transmitting abnormal condition information on the detected abnormal condition from the managed device to the management device; receiving the abnormal condition information at the management device to store and manage the received abnormal condition information; detecting removal of the previously detected abnormal condition from a corresponding one of the managed devices, the corresponding managed device defining an originating managed device; transmitting from the managed device to the management device an abnormal condition removal call corresponding to the previously detected abnormal condition; receiving the abnormal condition removal call at the management device; and deleting a corresponding one of the abnormal condition information stored at the management device based upon the received abnormal condition removal call.

According to a third aspect of the current invention, a management apparatus for remotely managing a plurality of predetermined managed apparatuses over a computer network, each of the managed apparatuses including an abnormal condition reporting unit for reporting to the management apparatus abnormal condition information on an abnormal condition that is detected in the managed apparatus and a abnormal condition removal reporting unit for reporting to the management apparatus abnormal condition removal information if the detected abnormal condition has been removed in the managed apparatus, a corresponding one of the managed apparatus that is transmitting the abnormal condition removal information defining an originating managed apparatus, including: a communication unit for communicating with the managed apparatuses for receiving the abnormal condition information and the abnormal condition removal information; an abnormal condition information management unit connected to the communication unit for storing and managing the abnormal condition information that is received from the managed apparatuses; and an abnormal condition removal determination unit connected to the abnormal condition information management unit and the communication unit for determining whether or not the abnormal condition has been removed from the managed apparatus based upon the abnormal condition removal information.

According to a fourth aspect of the current invention, a remote management system for managing devices over a computer network, including: a plurality of predetermined managed apparatuses, each of the managed apparatuses further including: a first communication unit for communicating with devices; a detection unit for detecting an abnormal condition within the managed apparatus; an abnormal condition reporting unit connected to the first communication unit for reporting abnormal condition information on the detected abnormal condition; and a abnormal condition removal reporting unit connected to the first communication unit for reporting abnormal condition removal information if the detected abnormal condition has been removed in the managed apparatus, a corresponding one of the managed apparatus that is transmitting the abnormal condition removal information defining an originating managed apparatus; a management apparatus including: a second communication unit for communicating with the managed apparatuses for receiving the abnormal condition information and the abnormal condition removal information; an abnormal condition information management unit connected to the second communication unit for storing and managing the abnormal condition information that is received from the managed apparatuses; and an abnormal condition removal determination unit connected to the abnormal condition information management unit and the second communication unit for determining whether or not the abnormal condition has been removed from the managed apparatus based upon the abnormal condition removal information.

### BRIEF DESCRIPTION OF THE DRAWINGS

FIG. 1 is a conceptual diagram illustrating an example of the construction of the remote management system according to the current invention.

FIG. 2A is a conceptual diagram illustrating a case where a request to the management apparatus is generated at one of the managed apparatuses according to the current invention.

FIG. 2B is a conceptual diagram illustrating a case where a request to the managed apparatus is generated by the management apparatus according to the current invention.

FIG. 3 is a conceptual diagram illustrating a preferred embodiment of the image forming apparatus management system according to the current invention.

FIG. 4 is a block diagram illustrating a preferred embodiment of the physical construction of the image forming apparatus according to the current invention.

FIG. 5 is a block diagram illustrating an example of the software configuration of the image forming apparatus according to the current invention.

FIG. 6A is a timing chart illustrating examples of the operations of the ENGRDY signal and PWRCTL signal at the start-up of the image forming apparatus.

FIG. 6B is a timing chart illustrating examples of the operations of the ENGRDY signal and the PWRCTL signal when transit to an energy-saving mode.

FIG. 6C is a timing chart illustrating the case where return from the energy-saving mode is performed.

FIG. 7 is a functional block diagram illustrating one preferred embodiment of the construction of the NRS.

FIG. 8 is a block diagram showing an example of the physical construction of the management apparatus.

FIG. 9 is a diagram illustrating an exemplary communication sequence in transmitting and receiving data among the management apparatus, the intermediate apparatus, and the image forming apparatus.

FIG. 10 is a diagram illustrating another exemplary communication sequence in the case where data is transmitted from the image forming apparatus to the management apparatus 102.

FIG. 11 is a timing chart illustrating the communication sequence for receiving necessary information from the image forming apparatus for the management of the image forming apparatus in the remote management system according to the current invention.

FIG. 12 is a flow chart illustrating the steps involved in a preferred process of the power on initialization according to the current invention.

FIG. 13 is one exemplary format of the SC call SOAP message.

FIG. 14 is a table describing the major portion of the SC call SOAP message.

FIG. 15 is one exemplary format of the power activation report SOAP message in the HTTP message.

FIG. 16 is a table describing the major portion of the SC call removal SOAP message.

FIG. 17 is one exemplary format of the SC call removal SOAP message in the HTTP message.

FIG. 18 is a table describing the major portion of the SC call removal SOAP message.

FIG. 19 is a timing chart illustrating exemplary sequence of events after the SC occurrence and the SC removal due to the power reactivation.

FIG. 20 is a timing chart illustrating exemplary sequence of events after the SC has occurred and the corresponding SC is not removed.

FIG. 21 is a timing chart illustrating exemplary sequence of events after the SC has occurred and the corresponding SC is not removed even though the power activation has been attempted.

FIG. 22 is a table illustrating one exemplary storage format of the SC abnormality information in the abnormality information queue.

FIG. 23 is a table illustrating one exemplary device type database storing the device number and the corresponding proper second predetermined time t2 for each device.

FIG. 24 is a table illustrating an exemplary customer database.

FIG. 25 is a flow chart illustrating steps involved in a portion of the preferred process in response to the information received from the image forming apparatus according to the current invention.

FIG. 26 is a flow chart illustrating steps involved in the preferred process of supervisory handling according to the current invention.

FIG. 27 is a timing chart illustrating an exemplary situation that nothing in particular has been done after abnormality occurs and the abnormal condition has not been removed.

FIG. 28 is a timing chart illustrating an exemplary situation that after abnormality occurs, the abnormal condition has been removed by the power reactivation.

FIG. 29 is a timing chart illustrating an exemplary situation that after abnormality occurs, the abnormal condition has been removed by the power reactivation.

FIG. 30 is a timing chart illustrating an exemplary situation that after abnormality occurs, the abnormal condition has not been removed even after the power reactivation.

FIG. 31 is a timing chart illustrating a first exemplary management operation that after an initial abnormal condition, a new abnormal condition occurs before the initial abnormal condition is removed.

FIG. 32 is a timing chart illustrating a second exemplary management operation that after all abnormal conditions are removed, it is determined that the abnormal condition has been removed.

FIG. 33 is a flow chart illustrating steps to be added between the steps S17 and S18 of FIG. 25.

FIG. 34 is a timing chart illustrating in the sequence of performing a single SC removal call after all of the abnormal conditions have been removed.

FIG. 35 is a table illustrating an exemplary format for the management of the abnormal condition information that is different from the queue style as shown in FIG. 22.

FIG. 36 is a timing chart illustrating sequences for processing abnormal occurrence in the image forming apparatus according to a prior art remote management system.

FIG. 37 is a timing chart illustrating the data flow when the abnormal condition has not been removed FIG. 38 is a timing chart illustrating the data flow when the abnormal condition has been removed.

### DETAILED DESCRIPTION OF THE PREFERRED EMBODIMENT(S)

A specific description will now be given for preferred embodiments according to the present invention by referring to the drawings. First, a description will be given for an exemplary embodiment of a remote management system according to the present invention which manages an electronic apparatus to be managed (hereinafter referred to as a “managed apparatus”).

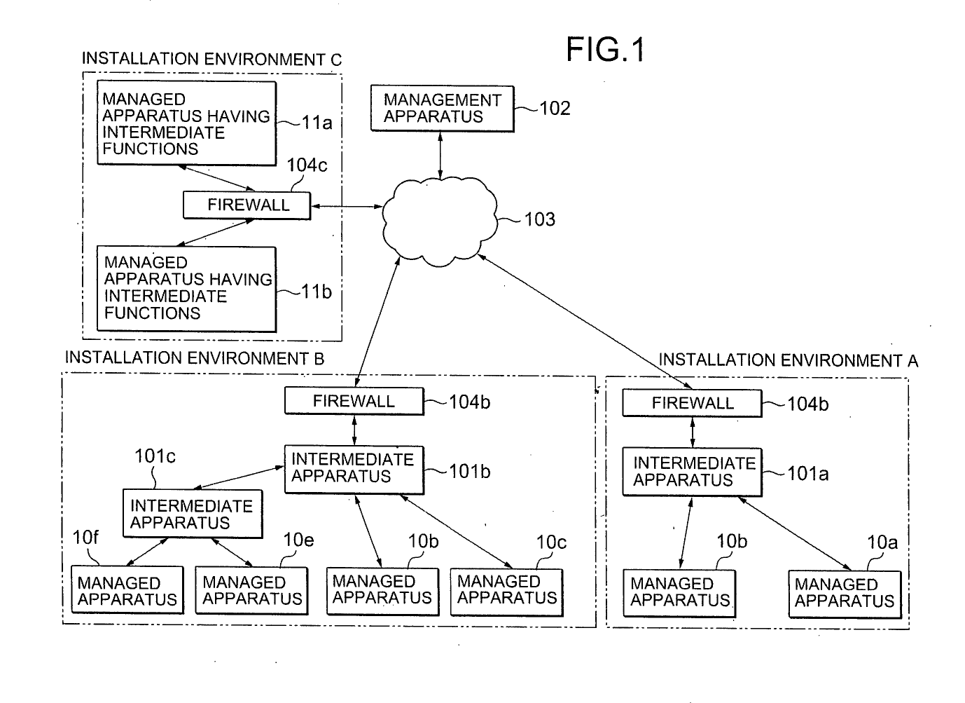

FIG. 1 is a conceptual diagram showing an example of the construction of the remote management system. The remote management system manages managed apparatuses 10 (10a, 10b, 10c, 10d, 10e, and 10f), which are image forming apparatuses such as a printer, a FAX apparatus, a digital copying apparatus, a scanner and a digital multi-functional apparatus, and communication apparatuses or electronic apparatuses such as network-based home appliances, automatic vending machines, medical equipment, power supply equipment, air conditioning systems and measuring systems of gas, water, electricity. The remote management system includes intermediate apparatuses 101 (101a, 101b, and 101c) that serve as remote management intermediate apparatuses which are connected with the managed apparatuses 10 via a local area network (LAN) external apparatuses. The managed apparatuses 10 are connected when they are seen from the managed apparatuses 10. Further, the remote management system includes a management apparatus 102 that functions as a server connected to the intermediate apparatuses 101 via, for example, the Internet 103. An alternative network such as a public line may also be used. In this way, the management system 102 remotely manages each of the managed apparatuses 10 via the intermediate apparatuses 101 in a centralized manner. The intermediate apparatuses 101 and the managed apparatuses 10 form various hierarchical structures in accordance with environment in which they are used.

The connection between the managed apparatus 10 and the intermediate apparatus 101 is not limited to LAN, but includes the serial connection such as the RS-485 standard and the parallel connection such as the Small Computer System Interface (SCSI) standard. In case of the RS-485 standard, up to five of the managed apparatuses 10 are serially connected to the intermediate apparatus 101. Furthermore, the managed apparatuses 10 and the intermediate apparatus 101 are layered in various manners depending upon the user environment.

For example, an installation environment A as shown in FIG. 1 has a simple structure where the intermediate apparatus 101a, which can establish direct connection with the management apparatus 102 by Hyper Text Transfer Protocol (HTTP), the intermediate apparatus 101a is connected to the managed apparatuses 10a and 10b. On the other hand, in an installation environment B as shown in FIG. 1, four managed apparatuses 10 (10c, 10d, 10e, and 10f) are installed. If only one intermediate apparatus 101 is installed, the processing load becomes heavy on the apparatus. For this reason, in the installation environment B, a hierarchical structure is formed. The intermediate apparatus 101b, which can establish direct connection with the management apparatus 102 by HTTP, is connected to another intermediate apparatus 101c, and the intermediate apparatus 101c is further connected to the managed apparatuses 10e and 10f. In this case, information transmitted from the management apparatus 102 for remotely managing the managed apparatuses 10e and 10f arrives at the managed apparatus 10e or 10f via the intermediate apparatus 101b and the intermediate apparatus 101c, which is a lower level node of the intermediate apparatus 101b.

In addition, as in an installation environment C, managed apparatuses 11a and 11b having intermediate functions (hereinafter also simply referred to as “managed apparatus”). The managed apparatuses 11a and 11b having the functions of an intermediate apparatus 101 may be connected to the management apparatus 102 via the Internet 103 without an intermediate apparatus. It is also possible to further connect a managed apparatus that is equivalent to the managed apparatus 10 to the managed apparatus 11 having intermediate functions, although the diagram fails to show such an arrangement.

Further, it should be noted that firewalls 104 (104a, 104b and 104c) are installed in the respective environments A, B and C for security. For example, the firewalls 104 are formed by proxy servers. In addition, it is also possible to connect a terminal unit such as a personal computer and an electronic apparatus (external apparatus) to each of the managed apparatuses 10 and 11 via a LAN. In such a remote management system, the intermediate apparatuses 101 run an application program for controlling and managing the managed apparatuses 10 that are connected with the intermediate apparatuses 101.

The management apparatus 102 installs an application program for controlling and managing each of the intermediate apparatuses 101 and for further controlling and managing the managed apparatuses 10 via the intermediate apparatuses 101. Each of the nodes in the remote management system, including the managed apparatuses 10, is capable of transmitting a “request” by remote procedure call (RPC) for processing in accordance with a method of the application program installed in each node and obtaining or receiving a “response” that is the result of the requested process by the RPC. The details will be described later.

That is, the intermediate apparatuses 101 or the managed apparatuses 10 connected thereto are generating a request to the management apparatus 102, transmitting the request to the management apparatus 102, and obtaining the response to the request. Similarly, the management apparatus 102 is generating a request, transmitting the same to the intermediate apparatuses 101 and obtaining the response to the request. The above requests include a request for causing the intermediate apparatuses 101 to transmit various other requests to the managed apparatuses 10 and to obtain responses from the managed apparatuses 10 via the intermediate apparatuses 101. Furthermore, in order to implement the RPC, well known communication protocols, techniques, specifications and the like are used and include SOAP (Simple Object Access Protocol), HTTP, FTP (File Transfer Protocol), COM (Component Object Model), and/or CORBA (Common Object Request Broker Architecture).

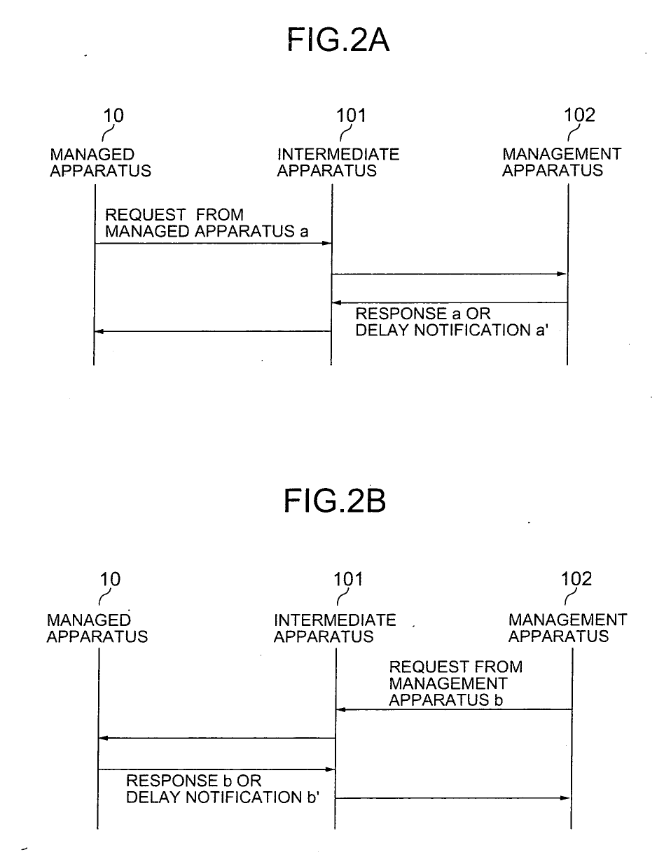

FIGS. 2A and 2B are conceptual diagrams illustrating data transmission and reception models of the above-mentioned transmission and reception. No firewalls 104 are considered in the conceptual diagrams. FIG. 2A illustrates a case where a request to the management apparatus 102 is generated at one of the managed apparatuses 10. The model in this case is as follows: the managed apparatus 10 generates a “request from the managed apparatus a”, and the management apparatus 102, receiving the request via the intermediate apparatus 101, returns a “response a.” The present invention also contemplates the case where the number of intermediate apparatuses 101 shown in FIG. 2A is two or more as in the installation environment B in FIG. 1. It should be noted that FIG. 2A shows the case where a “response delay notification a′” is returned in addition to the “response a”. This is because the management apparatus 102 is configured such that, when it is determined that the response to the request cannot be returned immediately in response to reception of the “request from the managed apparatus” via the intermediate apparatus 101, the response delay notification is transmitted and the connection is temporarily disconnected. The response to the request is then given later in a subsequent connection.

FIG. 2B illustrates a case where a request to the managed apparatus 10 is generated by the management apparatus 102. The model in this case is as follows: the management apparatus 102 generates a “request from the management apparatus b”, and the managed apparatus 10 which receives this request via the intermediate apparatus 101 returns a “response b.” In addition, similar to the case of FIG. 2A, in the case of FIG. 2B, a “response delay notification b′” is returned when the response cannot be returned immediately.

Next, a brief description will be given for an exemplary embodiment of the management apparatus 102 as shown in FIG. 1. The management apparatus 102 is constructed of a CPU, a ROM, a RAM, a non-volatile memory, a network interface card (hereinafter referred to as a “NIC”), and the like. A detailed description of the construction will be given later. Additionally, a brief description will be given for an exemplary embodiment of the intermediate apparatus 101 as shown in FIG. 1. The intermediate apparatus 101 is constructed of a CPU, a ROM, a RAM, a nonvolatile memory, NIC and the like. A detailed description of the construction will be given later.

Further, for the managed apparatus 11 having intermediate functions, the above-mentioned units or components may be simply added to the managed apparatus 10 so as to realize the functions of the intermediate apparatus 101. However, it is also possible to realize the functions of the intermediate apparatus 101 by using hardware resources provided to the managed apparatus 10, such as a CPU, a ROM, a RAM and the like, and causing the CPU to execute an appropriate application or a program module. Next, a description will be given of an image forming apparatus management system according to the present invention. The remote management system has an image forming apparatus or electronic apparatus as the managed apparatus. Such image forming apparatus is a more specific example of the remote management system as shown in FIG. 1.

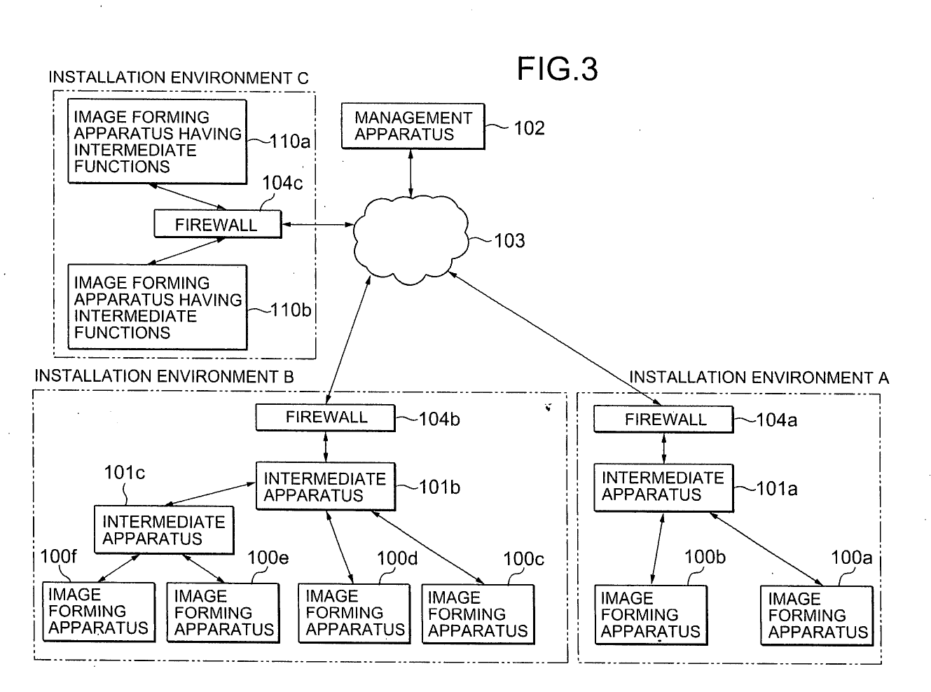

FIG. 3 is a conceptual diagram illustrating a preferred embodiment of the image forming apparatus management system according to the current invention. A description of the structure of the system will be given only to the extent that FIG. 3 differs from FIG. 1 in that the managed apparatuses 10 are changed to image forming apparatuses 100 and the managed apparatuses 11 with intermediate functions are changed to image forming apparatuses 110 having intermediate functions (hereinafter also referred to as “image forming apparatuses”). The image forming apparatuses 100 are digital multi-functional apparatuses having functions of devices such as a copying machine, facsimile apparatus, scanner, and the like and functions for communicating with an external apparatus. The image forming apparatuses 100 install an application program for providing services relating to the above-mentioned functions. In addition, the image forming apparatuses 110 having the intermediate functions are the image forming apparatuses 100 having the functions of the intermediate apparatuses 101.

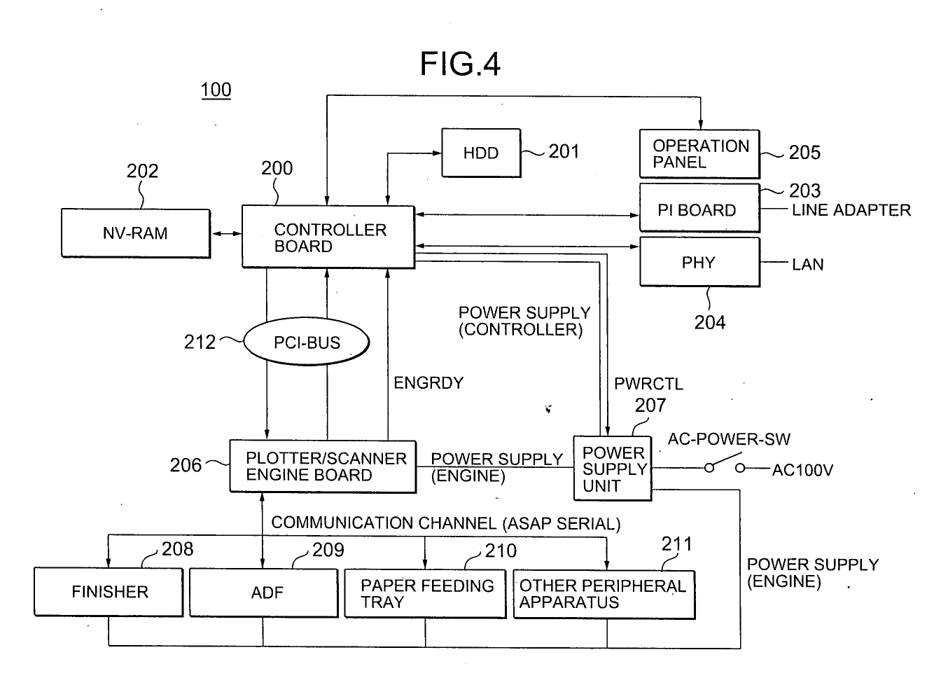

Referring to FIG. 4, a description will be given for a preferred embodiment of the image forming apparatus 100 according to the current invention. FIG. 4 is a block diagram illustrating a preferred embodiment of the physical construction of the image forming apparatus 100. As shown in FIG. 4, the image forming apparatus 100 includes a controller board 200, a HDD (hard disk drive) 201, a NV-RAM (nonvolatile RAM) 202, a PI (personal interface) board 203, a PHY (physical media interface) 204, an operation panel 205, a plotter/scanner engine board 206, a power supply unit 207, a finisher 208, an ADF (automatic document feeder) 209, a paper feeding tray 210, and other peripheral apparatus 211. Each of these units is a hardware resource of the image forming apparatus 100.

The controller board 200 corresponds to a control means. The controller 200 includes a CPU (hereinafter also referred to as a “controller CPU”), a ROM, a RAM and the like and controls each function via a PCI-BUS (Peripheral Components Interconnect-Bus) 212. The RAM provided in the controller board 200 is a volatile storing means that stores information when power is supplied from the power supply unit 207. The HDD 201 is a nonvolatile storing means or a recording medium that stores information or data irrespective of the power supply status from the power supply unit 207. The NV-RAM 202 is a nonvolatile storing means and may be realized by using nonvolatile memory such as EEPROM, flash memory, and nonvolatile RAM on which RAM and a backup circuit using a battery are integrated. The PI board 203 and the PHY 204 correspond to a communication means and are for external communication. For example, a communication board or the like corresponds to the PI board 203 and the PHY 204. The PI board 203 includes an interface conforming to the RS485 standard and is connected to a public line via a line adapter. Examples of the public line are fixed telephone lines such as an analog circuit, an ADSL circuit, a digital circuit (ISDN circuit), and a circuit using optical fiber: and wireless phone lines such as mobile phone lines and PHS lines. The PHY 204 is an interface for communicating with another electronic apparatus or a terminal unit such as a personal computer via a LAN. The operation panel 205 is an operation means including an operation part having various operation input keys which are also referred to as operation switches or operation buttons and a display unit having a character display portion such as an LCD or a CRT. An ENGRDY in FIG. 4 is a signal line for informing the controller board 200 that various initial settings of an engine unit or plotter/scanner engine board 206 are completed and that the transmission and reception of a command to and from the controller board 200 are ready. In addition, a PWRCTL is a signal line for controlling power supply to the engine unit by the controller board 200. The operations of the above-mentioned signal lines will be further described later.

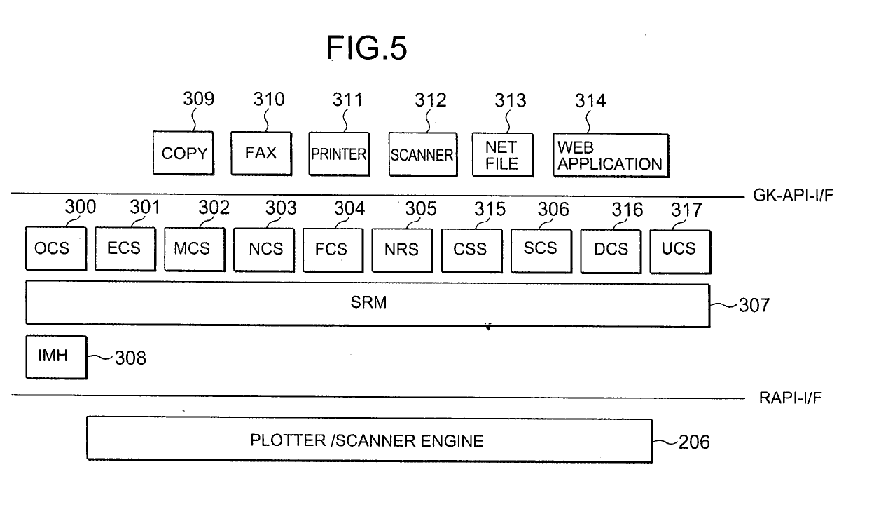

Next, referring to FIG. 5, a description will be given for a preferred embodiment in a software configuration of the image forming apparatus 100. FIG. 5 is a block diagram illustrating an example of the software configuration of the image forming apparatus 100 according to the current invention. The software configuration of the image forming apparatus 100 is formed by an application module upper layer, a service module middle layer, and a versatile OS lower layer. Programs forming the software are stored in the HDD 201 or the RAM on the controller board 200, are read out according to need, and executed by the controller CPU on the controller board 200. Also, the programs may be stored in a recording medium such as an optical disk (for example, a CD-ROM, a CD-R, a DVD-R, and a DVD-ROM), a magneto optical disk (for example, an MO), a flexible disk, and the like.

The controller CPU implements various functions including an abnormality information transmission means, an abnormality removal means and a power on or activation report means. Among the above-mentioned functions, those functions relating to communication with the management apparatus 102 are realized differently between the image forming apparatuses 100 and the image forming apparatuses 110. That is, in the case of the image forming apparatuses 110, the image forming apparatuses 110 are provided with the functions of the intermediate apparatuses 101. Thus, it is possible to for the image forming apparatuses 110 to realize the functions relating to communication with the management apparatus 102 by executing the corresponding program by the controller CPU. On the other hand, in the case of the image forming apparatuses 100, it is possible to realize the functions relating to communication with the management apparatus 102 by executing the corresponding program by the controller CPU and by using the intermediate apparatuses 101. Additionally, the image forming apparatus 100 is provided with a sensor in the engine unit, which includes a scanner engine and a plotter engine (image formation means). The sensor is for detecting an event such as abnormality.

The service module layer includes an operation control service (OCS) 300, an engine control service (ECS) 301, a memory control service (MCS) 302, a network control service (NCS) 303, a FAX control service (FCS) 304, a new remote service (NRS) 305, a system control service (SCS) 306, a system resource manager (SRM) 307, an image memory handler (IMH) 308, a customer support system (CSS) 315, a delivery control service (DCS) 316, and a user control service (UCS) 317. Also, the application module layer includes a copy application 309, a FAX application 310, a printer application 311, a scanner application 312, a Net File application 313, and a web application 314. Further, the versatile OS layer installs a versatile OS 320.

A more detailed description of the above-mentioned modules and applications will be given below. The OCS 300 is a module for controlling the operation panel 205. The ECS 301 is a module for controlling the engine unit such as the hardware resources. The MCS 302 is a module for performing memory control. For example, the MCS 302 obtains and releases image memory, and uses the HDD 201. The NCS 303 is a module for performing an intermediate process between a network and each application program in the application module layer. The FCS 304 is a module for performing facsimile transmission and reception, facsimile reading, facsimile reception and printing, and the like. The SCS 306 is a module for the activation and deactivation management of each application program in the application module layer based upon the contents of a command. The SRM 307 is a module for performing system control and resource management. The IMH 308 is a module for managing memory which temporarily stores image data. The CSS 315 is a module for converting data upon transmitting and receiving the data over a public line. The CSS 315 is a module that organizes functions related to the remote management over the public line. The DCS 316 is a module for transmitting and receiving an image file or the like stored (to be stored) in the HDD 201 or the memory on the controller board 200 by using SMTP (Simple Mail Transfer Protocol) or FTP (File Transfer Protocol). The UCS 317 is a module for managing user information, such as destination information and address information that are registered by a user of the apparatus. The copy application 309 is an application program for realizing copy service. The FAX application 310 is an application program for realizing FAX service. The printer application 311 is an application program for realizing printer service. The scanner application 312 is an application program for realizing scanner service. The Net File application 313 is an application program for realizing Net File service. The web application 314 is an application program for realizing web service.

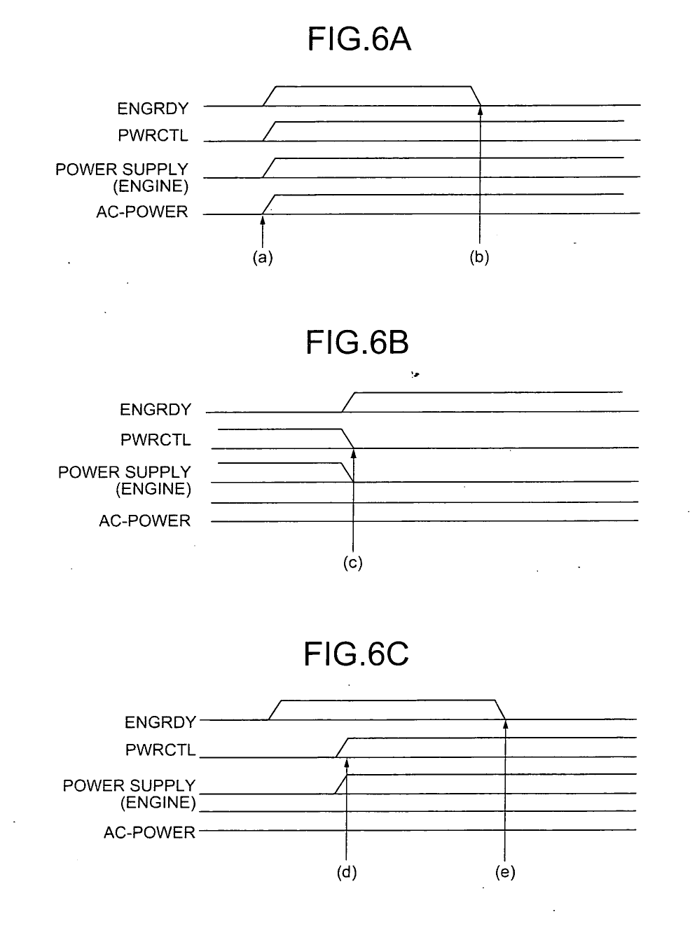

Referring to FIGS. 6A, 6B and 6C, a description will be given of the operations of the above-mentioned ENGRDY signal and PWRCTL signal. FIG. 6A shows examples of the operations of the ENGRDY signal and PWRCTL signal at the start-up of the image forming apparatus 100. When a main power supply switch (AC-POWER-SW) is turned ON at a point (a) in FIG. 6A and power is supplied to the power supply unit or main power supply 207 from a power supply part of an AC 100V simultaneously the ENGRDY signal becomes HIGH. In this state, communication with the engine unit cannot be performed because initial setting of the engine unit is not completed. Communication with the engine unit becomes possible when initial setting of the engine unit is completed after a predetermined amount of time and the ENGRDY signal becomes LOW as indicated by a point (b) in FIG. 6A.

Next, FIG. 6B shows examples of the operations of the ENGRDY signal and the PWRCTL signal in transition to an energy-saving mode. To enter into the energy-saving mode, the PWRCTL signal is turned OFF by the controller board 200. Simultaneously, power supply to the engine unit from the power supply unit 207 is stopped. Based on this, the ENGRDY signal becomes HIGH and transition to the energy-saving mode is performed.

Next, FIG. 6C illustrates the case where return from the energy-saving mode is performed. FIG. 6C shows examples of the operations of the ENGRDY signal and the PWRCTL signal in returning from the energy-saving mode to an ON-state. Upon returning from the energy-saving mode of FIG. 6B, the PWRCTL signal is turned ON by the controller board 200 as indicated by a point (d) in FIG. 6C. Simultaneously, power is supplied to the engine unit from the power supply unit 207. However, as shown in FIG. 6A, the ENGRDY signal remains HIGH until the initial setting of the engine unit is completed. When the initial setting is attained, communication with the engine unit is enabled, and the ENGRDY signal becomes LOW as indicated by a point e in FIG. 6C.

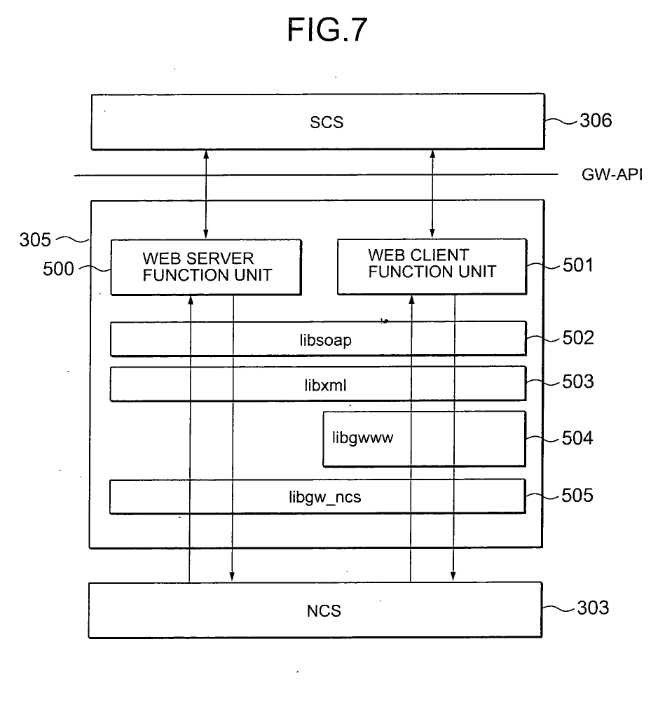

Next, referring to FIG. 7, a further description will be given for preferred embodiment of the NRS 305, which is included in the software of the image forming apparatus 100. FIG. 7 is a functional block diagram illustrating one preferred embodiment of the construction of the NRS 305. As shown in FIG. 7, the NRS 305 performs processes between the SCS 306 and the NCS 303. A web server function part 500 performs a response process for a request received from the outside. The request may be, for example, a SOAP request according to the SOAP (Simple Object Access Protocol) described in a structured language such as the XML (Extensible Markup Language) format. The web client function part 501 performs a process of issuing a request to the outside. A libsoap 502 is a library that processes data in the SOAP format. A libxml 503 is a library that processes data described in the XML format. In addition, a libgwww 504 is a library that processes data in the HTTP format. A libgw_ncs 505 is a library that performs processes with respect to the NCS 303.

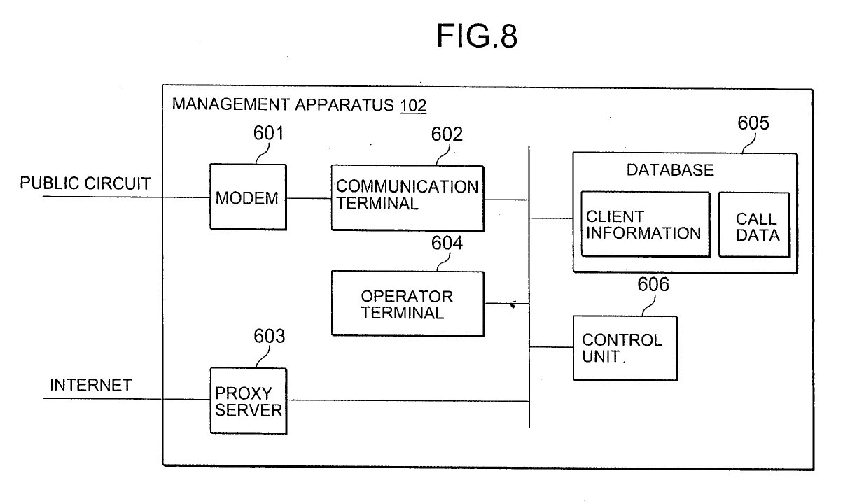

Next, referring to FIG. 8, a description will be given for a preferred embodiment of the management apparatus 102. FIG. 8 is a block diagram showing an example of the physical construction of the management apparatus 102. The management apparatus 102 includes a modem 601, a communication terminal 602, a proxy server 603, an operator terminal 604, a database 605, a control unit 606, and the like. The modem 601 communicates with the intermediate apparatus 101 or the image forming apparatus 110. For example, the user's destination is the image forming apparatus via a public line. The modem 601 respectively modulates and demodulates transmission data and reception data. The modem 601 serves as communication means together with the communication terminal 602, which will be described later. The communication terminal 602 controls data transmission and reception between the intermediate apparatus 101 and the line adapter via a public line. The proxy server 603 performs security management and communication with the intermediate apparatus 101 on the user's end via the Internet. The proxy server 603 also serves as the communication means.

The operator terminal 604 is a terminal that the management center operator operates. The operator terminal 604 accepts inputs of various data via an input device such as a keyboard when an operation is conducted thereon by the user and displays the information to be reported to the operator. The input data includes client information such as IP addresses and telephone numbers that are used to communicate with the intermediate apparatus 101 or the image forming device 110 on the device user side. The database 605 exists in a storage unit such as a hard disk of a server that is not shown in the figure. The database 605 stores the IP addresses and the telephone numbers of the intermediate apparatus 101 and the image forming apparatus 110 of the each device user, data received from the above devices, data input from the operation terminal 604, device and customer databases to be described later and various data including the software programs according to the current invention. The control unit 606 is provided with a micro computer formed by a CPU, ROM, RAM and the like, that are not shown in the figure. The control unit 606 centrally controls the management apparatus 102. Various functions of the transmission result notification means are realized according to the current invention by operating the CPU in accordance with the programs, carrying out the programs according to need and selectively using the modem 601, the communication terminal 602, the proxy server 603, an operator terminal 604 or the database 605.

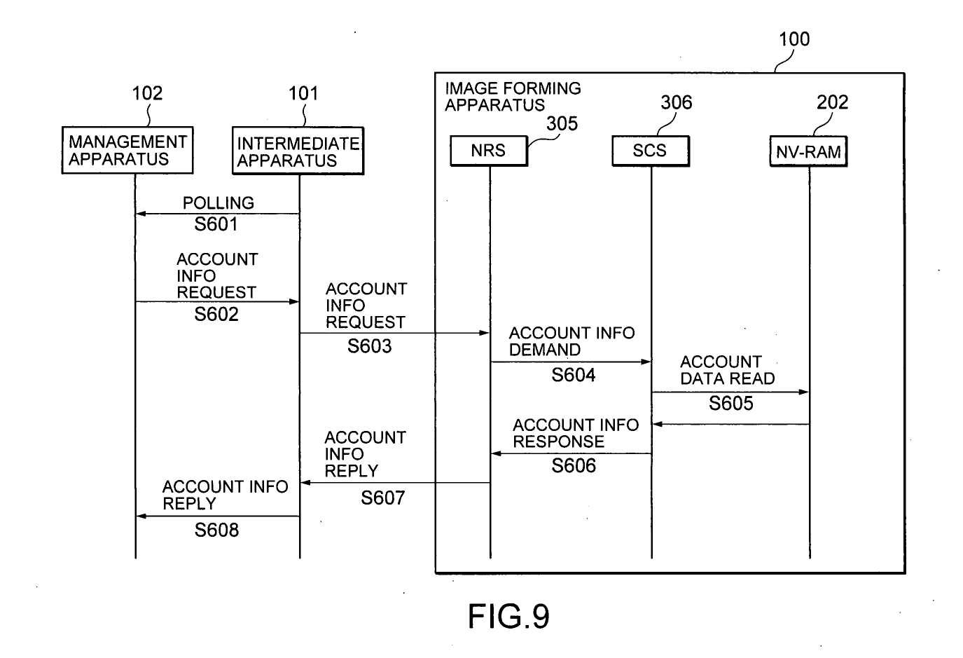

Referring to FIG. 9, based on the above-mentioned construction, a description will be given for an exemplary communication sequence in transmitting and receiving data in the image forming apparatus management system as shown in FIG. 3. Processes by the SCS 306 and the NRS 305, which are explained below, are actually carried out by operations of the controller CPU in accordance with the programs. However, for convenience of explanation, it is assumed that the processes are carried out by the programs. In the following, when the program is described to perform a process, the same explanation will be given. FIG. 9 is a diagram illustrating an exemplary communication sequence in transmitting and receiving data among the management apparatus 102, the intermediate apparatus 101, and the image forming apparatus 100. In this example, first, in step S601, the intermediate apparatus 101 polls to inquire as to whether or not there is a transmission request to the management apparatus 102. In other words, the intermediate apparatus 101 generates an HTTP message including a SOAP message for polling to which an identifier representing self-identification information is added. Then, the intermediate apparatus 101 transmits the HTTP message to the management apparatus 102. As shown in FIG. 3, since the firewalls are installed between the intermediate apparatus 101 and the management apparatus 102, a communication session from the management apparatus 102 to the intermediate apparatus 101 is not held. When a request is desired from the management apparatus 102 to the intermediate apparatus 101 or the image forming apparatus via the intermediate apparatus 101, it is necessary to wait for the polling process from the intermediate apparatus 101.

When the management apparatus 102 receives the HTTP message from the intermediate apparatus 101, the management apparatus 102 generates an HTTP message including a SOAP message representing an accounting counter data obtaining request and transmits the request to the intermediate apparatus 101. In step S602, the intermediate apparatus 101 is the transmitting source of the received SOAP message. On this occasion, the corresponding intermediate apparatus 101 is identified based on the identifier added to the SOAP message in the received HTTP message. As above, if it is a HTTP response for a HTTP request from the inside of the firewalls 104, data is transmitted from the outside to the inside of the firewalls 104.

When the intermediate apparatus 101 receives the HTTP message from the management apparatus 102, the intermediate apparatus 101 generates a SOAP message representing the accounting counter data obtaining request based on the HTTP message and transmits the request to the NRS 305 of the image forming apparatus 100 that is connected to the same intermediate apparatus 101 in step S603. In step S604, the NRS 305 notifies the SCS 306 of the accounting counter data obtaining request in the SOAP message that is received from the intermediate apparatus 101. When the SCS 306 receives the notification of the accounting counter data obtaining request from the NRS 305, the SCS 306 reads data for the accounting counter stored in the NV-RAM 202 in step S605. Then, in step S606, the SCS 306 transmits the read data or response data of accounting counter to the NRS 305. When the NRS 305 receives the data of accounting counter from the SCS 306, the NRS 305 generates a SOAP message for accounting counter, representing the contents of the data, converts the received data into the XML format that is a structured language format, and transmits the message to the intermediate apparatus 101 in step S607. When the intermediate apparatus 101 receives the SOAP message for accounting counter from the NRS 305, the intermediate apparatus 101 generates an HTTP message based on the SOAP message and transmits the message to the management apparatus 102 in step S608. In this manner, transmission and reception of data are performed according to the above-mentioned communication sequence.

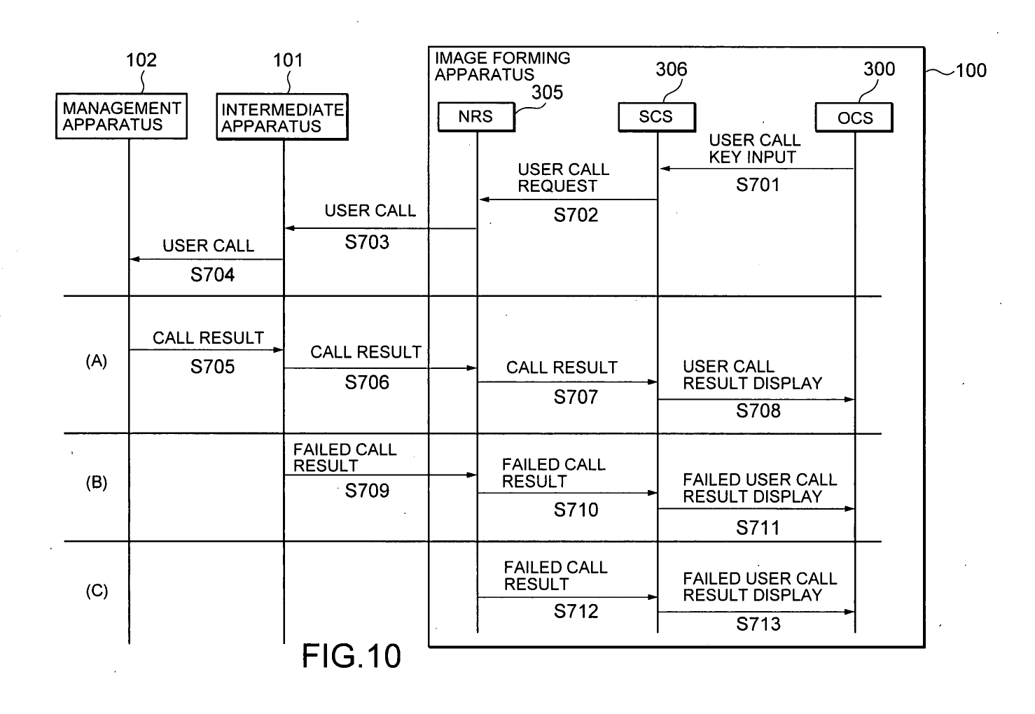

Next, referring to FIG. 10, a description will be given for an exemplary communication sequence in the case where, unlike the case shown in FIG. 9, data are transmitted to the management apparatus 102 from the image forming apparatus 100 via the intermediate apparatus 101. FIG. 10 is a diagram illustrating another exemplary communication sequence in the case where data is transmitted from the image forming apparatus 100 to the management apparatus 102. In this example, first, in step S701, the OCS 300 notifies the SCS 306 that a user call key on the operation panel 205 is pressed down. When the SCS 306 receives from the OCS 300 the notification that the user call key is pressed down, the SCS 306 notifies the NRS 305 of a user call request in step S702. When the NRS 305 receives from the SCS 306 the notification of the user call request, the NRS 305 generates a SOAP message for the user call information on the user call and transmits the message to the intermediate apparatus 101 in step S703. When the intermediate apparatus 101 receives from the NRS 305 the SOAP message for user call, the intermediate apparatus 101 adds an identifier representing self-identification information to the SOAP message, further generates an HTTP message based on the SOAP message, and makes a user call with respect to the management apparatus 102. That is, in step S704, the intermediate apparatus 101 reports to the management apparatus 102 via the HTTP message including the user call SOAP message with the self-identifier. In this case, since the transmission is from the inside to the outside of the firewalls 104, the intermediate apparatus 101 holds a communication session with the management apparatus 102 for transferring the data.

Here, process patterns after the step S704 will be explained by dividing the patterns into (A), (B), and (C). First, in the pattern (A), the management apparatus 102 receives the HTTP message including the user call SOAP message from the intermediate apparatus 101 on the user's side. When the reception ends normally, the management apparatus 102 generates an HTTP message including a SOAP message representing the successful result of the user call and transmits the message to the reporting source intermediate apparatus 101 in step S705. On the other hand, when the reception does not end normally or ends abnormally, the management apparatus 102 generates an HTTP message including a SOAP message representing the result of the user call and transmits the message to the reporting source intermediate apparatus 101 also in the step S705.

When the intermediate apparatus 101 receives from the management apparatus 102 the HTTP message including the SOAP message representing the result of the call, in step S706, the intermediate apparatus 101 generates a SOAP message representing the result of the call based on the HTTP message and transmits the message to the NRS 305 of the image forming apparatus 100 whose user call key has been pressed down. When the NRS 305 receives from the intermediate apparatus 101 the SOAP message representing the result of the call, the NRS 305 interprets or determines the result of the call represented by the SOAP message and reports it to the SCS 306 in step S707. When the SCS 306 receives the result of the call, the SCS 306 transmits it to the OCS 300 in step S708. When the OCS 300 receives the result of the call from the SCS 306, in step S708, the OCS 300 displays a message representing the contents on a character display unit of the operation panel 205. That is, the displayed message is whether the user call has been successful or failed.

In the pattern (B), when the intermediate apparatus 101 determines that there is no response from the management apparatus 102 after a predetermined time period has elapsed, in step S709, the intermediate apparatus 101 generates a SOAP message representing the result or failure of the call and transmits the message to the NRS 305. When the NRS 305 receives the SOAP message representing the failed result of the call, in step S710, the NRS 305 interprets the failed result of the call described in the SOAP message and reports it to the SCS 306. When the SCS 306 receives the result of the call from the NRS 305, the SCS 306 transmits the result to the OCS 300 in step S711. When the OCS 300 receives the result of the call from the SCS 306, the OCS 300 displays the contents, on the character display unit of the operation panel 205 in step S711. That is, the message represents the failure of the user call.

In the pattern (C), when the NRS 305 determines that there is no response from the intermediate apparatus 101 after a specified time has elapsed, the NRS 305 reports the failed result of the user call to the SCS 306 in step S712. When the SCS 306 receives the result of the call from the NRS 305, the SCS 306 transmits it to the OCS 300 in step S713. When the OCS 300 receives the result of the call from the SCS 306, in step S713, the OCS 300 displays the message contents, representing the failed user call on the character display unit of the operation panel 205.

In order to transmit the data from the management apparatus 102 to the intermediate apparatus 101 or the image forming apparatus 100 via the intermediate apparatus 101 over the firewalls, it was described above that the data is transmitted in the form of the HTTP response in response to the HTTP request from the intermediate apparatus 101. The method for jumping over the firewalls is not limited to the above described technique. For example, data is transmitted from the management apparatus 102 to the intermediate apparatus 101 in the mail or as an attachment to the mail based upon Simple Mail Transfer Protocol (SMTP). However, the HTTP technique is superior to the SMTP in terms of reliability.

Next, as shown in FIG. 3, the operation and the components for receiving and processing a SC call or an abnormality report at the management apparatus 102 from the managed apparatus or the image forming apparatus 100 in the image forming apparatus remote management system according to the current invention. The image forming apparatus 100 in the image forming apparatus remote management system is equipped with both a communication unit for the private line as well as a communication unit for network. The image forming apparatus 100 is designed to be a target of the remote service (RS) by the customer support system method to communicate with the management apparatus 102 via the public line and the intermediate apparatus 101. Alternatively, the image forming apparatus 100 is designed to be a target of the RS by the new remote service (NRS) method to communicate with the management apparatus 102 via the Internet and the intermediate apparatus 101. Since the image forming apparatus 110 is equipped with the functions of the intermediate apparatus 101, the image forming apparatus 110 is designed to be a target of the remote service management by the customer support system method to communicate with the management apparatus 102 via the public line and the intermediate apparatus 101 as well as a by the new remote service method to communicate with the management apparatus 102 via the Internet and the intermediate apparatus 101.

The image forming apparatuses 100 and 110 are equipped with the programs such as the CSS 315 corresponding to the customer support system method and the NRS 305 corresponding to the new remote service method for transmitting information representing the state of the engine unit and for reporting to the management apparatus 102 event information when an event-causing report occurs in the hardware resources such as the engine unit.

For convenience of explanation, a description will be given for the processes according to the present invention where the image forming apparatus 100 uses the NRS 305. Only a scanner engine and a plotter engine are considered to be an engine unit. It should be noted that the processes according to the present invention may also be performed by the image forming apparatus 100 using the CSS 315. In addition, the processes according to the present invention may also be performed by the image forming apparatus 110 using the NRS 305 or the CSS 315.

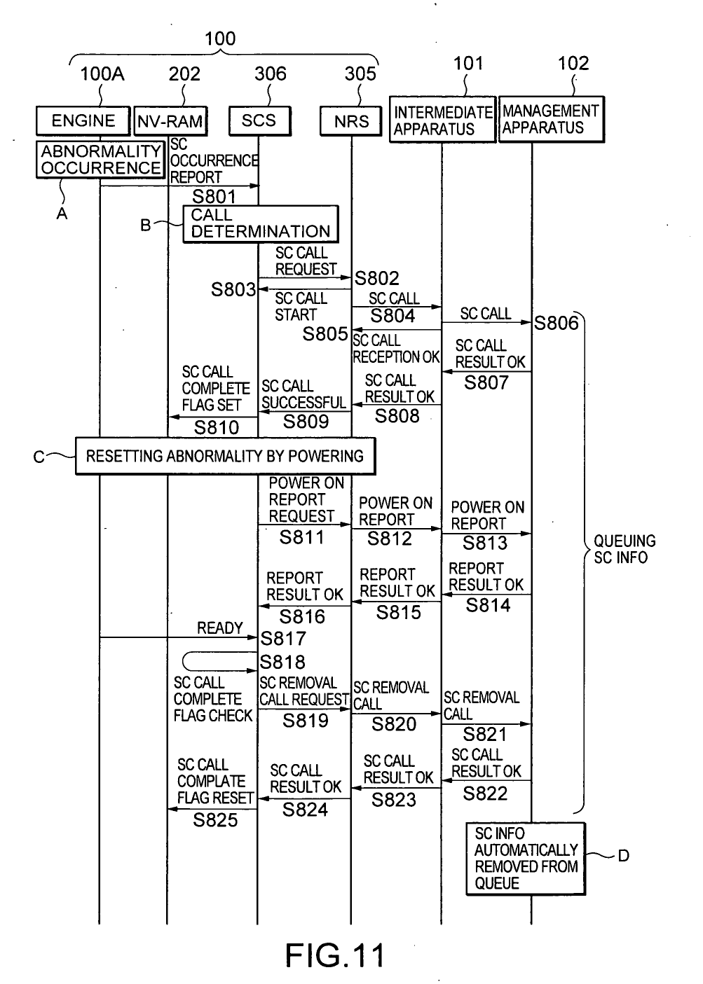

Now referring to FIG. 11, a timing chart illustrates the communication sequence for receiving necessary information from the image forming apparatus for the management of the image forming apparatus in the remote management system according to the current invention. The image forming apparatus 100 includes an abnormal detection unit such as a sensor in an engine unit 100A to detect a predetermined set of abnormality conditions in the engine unit 100A. A corresponding detection unit detects an abnormality condition as a service man (SC) call in an event A and reports the abnormal condition occurrence to the SCS 306 of the controller board 200 in a step 801. In receiving the report for the SC from the engine unit 10A, the SCS 306 determines that the SC has occurred in the engine unit 100A in an event B and issues a transmission request in a step S802 to the NRS 305 for the SC call, which is an automatic report for the abnormal condition. In response to the SC call from the SCS 306, the NRS 305 reports to the SCS 306 about the initiation of the received SC call in a step S803. At the same time, the NRS 305 generates a SOAM message for the SC call for reporting the information on the abnormal condition and transmits it to the intermediate apparatus 101 in a step S804. After receiving the SC call initiation report, the SCS 306 displays the message indicative of the transmission of the SC call to the management apparatus 102 on the character display of the operation panel 205. Upon receiving the SC call SOAP message from the NRS 305, the intermediate apparatus 101 reports to the NRS the call reception OK in a step S805 and adds its device identifier to the SOAP message. The intermediate apparatus 101 further generates a HTTP message based upon the SOAP message and performs a corresponding SC call to the management apparatus 102 via the Internet in a step S806. That is, the HTTP message including the SC call SOAP message with the self device identifier is automatically reported to the management apparatus 102 via the Internet. In the above, the CPU on the controller board 200 in the image forming apparatus 100 especially in the process of the steps S802 and S804 executes the SCS 306 and the NRS 305 to function as an abnormal condition reporting means.

In case that it is set that the SC call is not made by the keyboard on the operation panel 205, even if the SCS 306 receives the SC call from the engine unit 100A, the SC call is not reported. In that case, a message indicative of malfunction is displayed on the character display on the operation panel 205, and it is recommended to the user to contact the service center. On the other hand, upon receiving a HTTP message including the SC call SOAP message from the intermediate apparatus at the device side and a successful completion of the reception, in a step S807, the management apparatus 102 generates a HTTP message including a call result OK SOAP message and transmits it to the originating intermediate apparatus 101 via the Internet 103 based upon the identifier added the SOAP message in the received HTTP message. The originating intermediate apparatus 101 transmitted to the HTTP message including the SC call SOAP message. Furthermore, the necessary SC information is extracted from the SOAP message in the received HTTP message, and the extracted SC information is stored and managed in the abnormality information queue until the abnormal condition for the corresponding SC information is resolved. The CPU on the control unit 606 in the management apparatus 102 executes software programs for controlling various units in the management apparatus 102 to function as an abnormality information management means.

The content of the received SC information at this point is displayed on the display unit to inform the operator. As described with respect to the prior art technologies, there are some situations where no response is necessary at the management center even when abnormality has occurred, only when it is determined that a response is necessary as described later, the center operator is reported. In case of the SC information content is to be reported at the time of the SC call reception and it is determined that the corresponding response is necessary, the center operator's attention is drawn to a color change in the display or an audible alarm sound. When the HTTP message including the SOAP message transmitted from the intermediate apparatus 101 at the device user side is not normally received or the SC call process is failed, a HTTP message containing a SOAP message indicative of the failure is generated and is transmitted to the originating intermediate apparatus 101 via the Internet 103 based upon the identifier in the SOAP message of the received HTTP.

Upon receiving the HTTP message with the SOAP message indicative of the call result OK in response to the automatic report of the HTTP message including the SC call SOAP message to the management apparatus 102, the intermediate apparatus 101 generates a SOAP message indicative of the call result OK based upon the received HTTP message and transmits the NRS 305 of the corresponding image forming apparatus 100 in a step S808. After receiving the SOAP message indicative of the call result OK from the intermediate apparatus 101, the NRS 305 reports to the SCS 306 that the SC call is normally terminated in a step S809. Subsequently, when the report is received from the NRS 305 that the SC call has been normally completed, a message indicative of a successful SC call is displayed on the character display on the operation panel 205. Furthermore, the SCS 306 sets the value 1 in a SC call complete flag indicative of the successful SC call on the NV-RAM 202 in a step S810. The SC call complete flag is provide either for all categories or each of the categories of the SC. In the current preferred embodiment, the SC call complete flag is provided for each category.

Subsequently, the abnormality detection unit of the engine unit 100A confirms whether or not the abnormality has been resolved and continues to monitor a predetermined set of abnormal conditions. As described before with respect to the prior art technologies, there are some abnormal conditions that are reset or resolved by turning off and on the power supply. The sequence following the step S811 in FIG. 11 illustrates a situation where the temporary power supply deactivation has resolved the pending abnormality and the corresponding SC call has been removed. Although the following sequence fails to report the result as in the steps 803 and 805 for the SC call, the comparable reports may be provided in the preferred embodiment. By the same token, in the process where the call is not normally handled, the similar report may be provided.

When the power supply is deactivated and subsequently activated as in an event C, after the system is initialized, the communication is enabled. The SCS 306 first issues a transmission request for a report to the NRS 305 on the activated power supply in a step S811. In response to the transmission request for a report on the activated power supply, the NRS 305 generates a SOAP message for the power supply activation and transmits it to the intermediate apparatus 101 in a step S812. Upon receiving the SOAP message for the power supply activation from the NRS 306, the intermediate apparatus 101 adds its device identifier to the SOAP message, subsequently generates a HTTP message based upon the above SOAP message and transmits the above generated power activation report to the management apparatus 102 via the Internet 103 in a step a S813. In other words, the HTTP message containing the power activation SOAP message with the self identifier is automatically transmitted to the management apparatus 102 via the Internet. In the process in the steps S811 and S812, the CPU executes the tasks associated with the SCS 306 and the NRS 305 to function as a power activation ON report means.

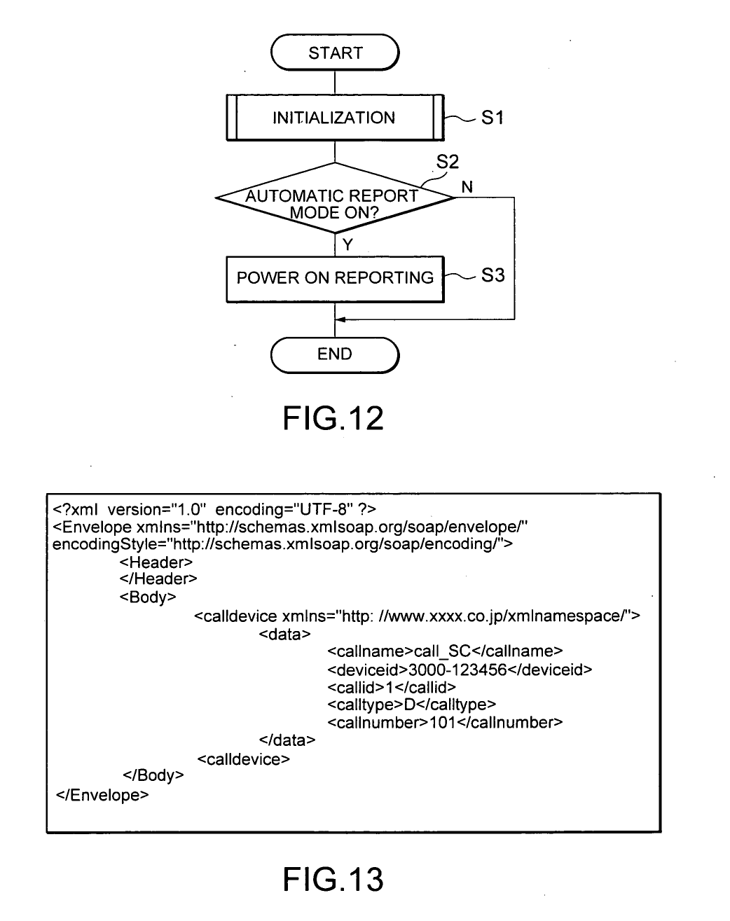

The SCS 306 performs the initialization routine as illustrated in FIG. 12. FIG. 12 is a flow chart illustrating the steps involved in a preferred process of the power on initialization or power activation according to the current invention. After a predetermined set of initialization tasks in a step S1, it is determined whether or not an abnormality automatic report mode for the SC call is turned on in a step S2. If it is determined in the step S2 that the abnormality automatic report mode is not on, the preferred process terminates the power on initialization routine.

On the other hand, if it is determined in the step S2 that the abnormality automatic report mode is on, the preferred process reports the power activation in a step S3 before terminating the routine. As will be described later, since the power activation report is used to determine whether or not the abnormality removal of the image forming apparatus 100 exists at the management apparatus 102, if the report is not automatically sent, the report does not necessarily bear significance. Even if the SC call complete flag is not ON, it is alternatively implemented not to report the power activation. As will be described later, the power activation report is effectively utilized for the management operation at the management apparatus 102 only when the abnormality information is transmitted from the originating devices that are managed by the management apparatus 102. As described above, the power activation report is omitted for unnecessary circumstances in order to reduce the processing load and the communication traffic.

Now referring back to FIG. 11, the management apparatus 102 performs the following tasks after successfully receiving the HTTP message containing the power activation SOAP message from the intermediate apparatus 101 at any of the device user side. The management apparatus 102 generates a HTTP message containing a SOAP message with a call result OK which indicates that the power activation report has been successfully processed. In a step S807, the management apparatus 102 transmits via the Internet 103 to the originating intermediate apparatus 101 based upon the identifier in the SOAP message of the above received HTTP. The originating intermediate apparatus 101 has transmitted the HTTP message containing a SOAP message with a call result OK.

The CPU of the management apparatus 102 executes the necessary programs for controlling various units of the management apparatus 102 to function as a power on report receiving means. The control unit 606 extracts the information on the power activation report in the received HTTP message and utilizes the extracted information for the management operation of the abnormality information as will be later described in detail. Upon receiving the HTTP message containing the call result OK SOAP message indicative of successful reception of the power activation report HTTP message from the management apparatus 102, the intermediate apparatus 101 generates a SOAP message indicative of the call result OK based upon the HTTP message and transmits to the corresponding NRS 305 of the image forming apparatus 100 in a step S815. In response to the call result OK SOAP message from the intermediate apparatus 101, the NRS 305 reports to the SCS 306 that the power activation report has been normally completed in a step S816.

On the other hand, when the main power supply is turned on, the engine unit 100A is also going through an initialization process. The abnormality detection unit also checks the status of each unit and reports the detected status to the SCS 306. By this time, if the abnormality has been removed, the engine unit 100A transmits a ready signal to the SCS 306 in a step S817. Due to the receipt of the reports, the SCS 306 confirms that there is no pending SC. It is determined in a step S818 whether or not the SC call complete flag is set to the value, 1. If it is determined in the step S818 that the SC call complete flag is set to the value, 1, a transmission request is issued to the NRS 305 for the SC removal call in a step S819. The SC removal call is an automatic report of the abnormality removal information for notifying the removal of the abnormality. Since each of the various sensors is located at parts of the engine to the ready signal to the SCS 306, the SCS 306 identifies normally operating units and abnormally operating units. Consequently, even if some abnormally functioning units exist, when one unit becomes operational and removes the abnormal condition, a SC removal call is transmitted for corresponding one of the remaining abnormally operating units.

After receiving the transmission request for the SC removal call from the SCS 306, the NRS 305 generates a SOAP message for the SC removal call as abnormality removal information for removing abnormality and transmits it to the intermediate apparatus 101 in a step S820. In turn, in response to the SC removal SOAP message from the NRS 305, the intermediate apparatus 101 adds its device identifier to the received SOAP message, generates a HTTP message based upon the above generated SOAP message, and transmits via the Internet the SC removal call to the management apparatus 102 in a step S821. That is, the HTTP message with the SC removal call SOAP message and the self identifier is automatically sent to the management apparatus 102 via the Internet. The CPU of the image forming apparatus executes the SCS 306 and the NRS 305 in the steps S819 and S820 to function as an abnormality removal reporting means.

Still referring to FIG. 11, the management apparatus 101 performs the following tasks after receiving the HTTP message with the SC removal SOAP message from the intermediate apparatus 101 at the device user side. If the HTTP message is successfully received, the management apparatus 102 generates a HTTP message including a SOAP message indicative of the call result OK for a successful SC removal process. Furthermore, the management apparatus 102 transmits via the Internet 103 the above generated HTTP message to the originating intermediate apparatus 101 based upon the identifier added in the SOAP message of the received HTTP message in a step S822. The CPU of the management apparatus 102 executes necessary software programs for controlling various units of the management apparatus 102 to function as an abnormality removal information receiving means. Furthermore, the control unit 606 extracts the abnormality removal information from the received HTTP message and utilizes the extracted information in the management of the abnormality information. For example, the SC information is automatically removed from the abnormality information queue under certain conditions as will be later described in detail.

In response to the automatic report of the HTTP message including the SC removal call SOAP message to the management apparatus 102, upon receiving the HTTP message including the call result OK SOAP message from the management apparatus 102, the intermediate apparatus 101 generates a call result OK SOAP message based upon the received HTTP message and transmits the generated HTTP message to the NRS 305 of the image forming apparatus 100 in a step S823. After receiving the call result OK SOAP message from the intermediate apparatus 101, the NRS 305 reports to the SCS 306 that the SC removal call has been successfully completed in a step S824. In turn, upon receiving the report indicative of the successful SC removal call from the NRS 305, the SCS 306 resets the SC call complete flag in the NV-RAM to “0” to indicate the removal in a step S825. As described above, the abnormality information for the image forming apparatus 100 is managed at the management apparatus 102 by using the sequence of transmitting the SC call on the abnormality information from the image forming apparatus 100 to the management apparatus 102, the power activation ON report and the SC removal call of the abnormality removal information. Furthermore, the SC removal call is transmitted not only after the power is reactivated, but also after the abnormality detection unit detects the removal or the resolution of the abnormal condition. In the later case, the SC removal call is transmitted independent of the power operation.

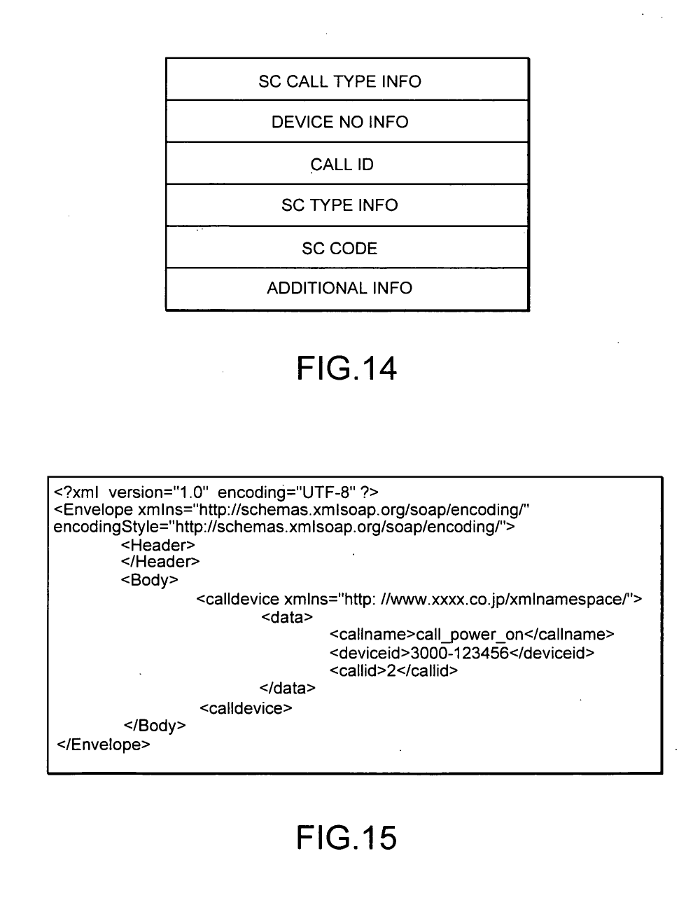

Now referring to FIGS. 13 through 18, exemplary formats of the SOAP messages are described. In the examples, the identifier for the intermediate apparatus 101 is not included. In the above described HTTP message, the SOAP messages for the SC call, the power activation report and the SC removal call are written in a structural language such as the XML format. FIG. 13 is one exemplary format of the SC call SOAP message while FIG. 14 is a table describing the major portion of the corresponding data. The SC call SOAP message includes a call type information to indicate the SC call, the device number information for the image forming apparatus 100 with the SC occurrence, a call ID for the call number, SC type information for indicating the type of the SC call and the SC code information for indicating the kind of the SC. In addition, as additional information, the SOAP message also includes the SC, jam, the status, the counter value and log information of the image forming apparatus 100 with the SC call. Since the SC code information is different for each type of the SC, the SC call SOAP message also differs for each type of abnormality. For the SC type information, the corresponding relation is stored at the management apparatus 102 between the SC code information and the SC type information. Using the SC code information as a key, the SC type information is obtained. For this reason, the SC type information is not necessarily included in the SC call SOAP message. Furthermore, the device number information includes the device type information on the image forming apparatus 100 as necessary.

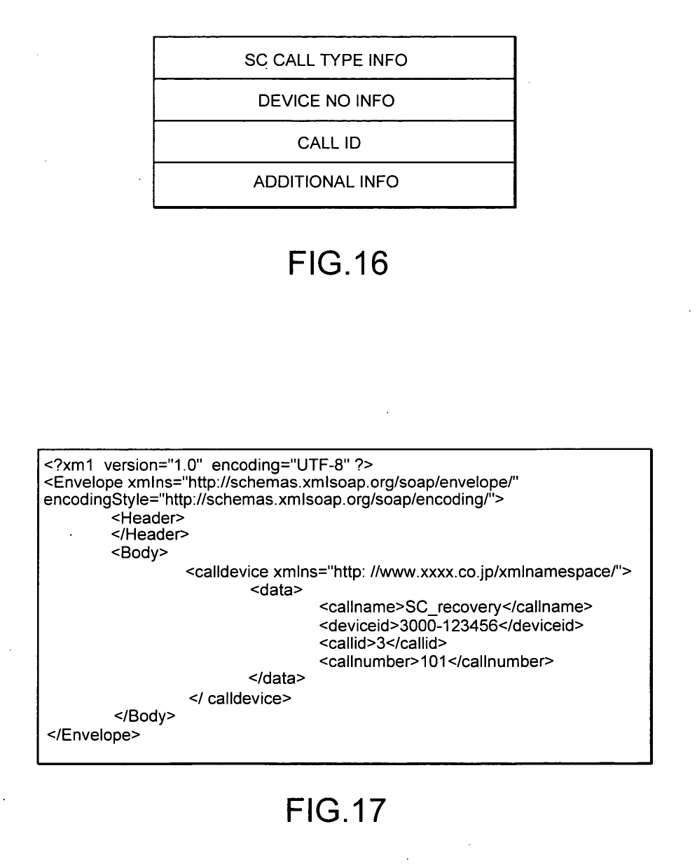

FIG. 15 is one exemplary format of the power activation report SOAP message in the HTTP message while FIG. 16 is a table describing the major portion of the corresponding data. The power activation report SOAP message includes call type information indicating a power activation report, device number information indicating the identifier of the image forming apparatus 100 of the power activation report and a call ID indicating the call identification number. As in the case of the SC call, other information is additionally included.

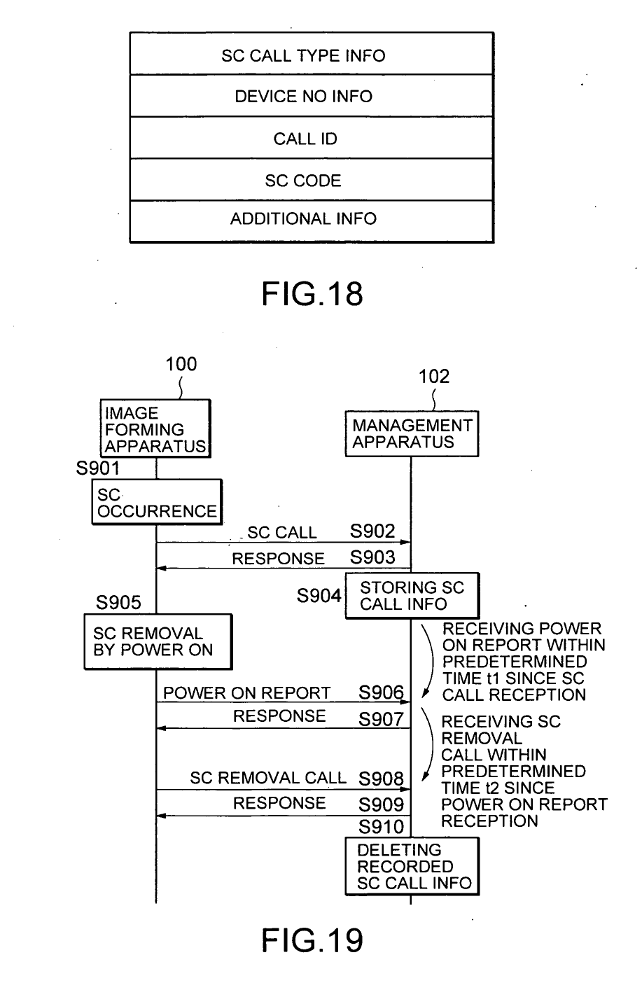

FIG. 17 is one exemplary format of the SC call removal SOAP message in the HTTP message while FIG. 18 is a table describing the major portion of the corresponding data. The SC call removal SOAP message includes call type information indicating a SC call removal, device number information indicating the identifier of the image forming apparatus 100 of the SC call removal, a call ID indicating the call identification number and the SC code information indicating a type of the removed SC. As in the case of the SC call, other information is additionally included. The SC code information utilizes a coding system similar to the SC call, and the SC removal call is a different set of information for a SC call corresponding to each type of the removed abnormality.

The management apparatus 102 manages the abnormality information based upon the above described SC calls, power activation reports and SC removal calls in the following sequence or steps as illustrated in FIGS. 19 through 21. FIGS. 19 through 21 omit the internal process of the image forming apparatus 100 and the data transmission paths between the image forming apparatus 100 and the management apparatus 102. FIG. 19 is a timing chart illustrating exemplary sequence of events after the SC occurrence and the SC removal due to the power reactivation. In a step S901, an abnormal condition occurs. The image forming apparatus 100 reports the abnormality information on the SC occurrence via SC call to the management apparatus 102 in a step S902. The management apparatus 102 returns a corresponding response result in a step S903 and stores the SC information contained in the SC call in the abnormality information queue in the database 605 in a step S904 as already described with respect to FIG. 11.

Now referring to FIG. 22, a table illustrates one exemplary storage format of the SC abnormality information in the abnormality information queue. Among the information, the device number, the SC code and the SC type are extracted from the data in the SC call while the SC reception time is obtained from an internal timer in the control unit 606. Furthermore, although the power activation flag is omitted in FIGS. 19 through 21, it is set after the SC information is stored and the power activation report is received. After the management apparatus 102 receives the SC call, the above either extracted or obtained information is stored in the abnormality queue. At this point, the center operator is not reported by displaying the information on the display unit of the operational terminal 604 until receiving the corresponding SC removal call for the SC call or the power activation report from the SC call origination source.

Referring back to FIG. 19, the following sequence will be described after the power supply is reactivated at the image forming apparatus 100 in a step S905. The image forming apparatus 100 transmits the power activation report to the management apparatus 102 in a step S906. In turn, the management apparatus 102 returns a corresponding response to the image forming apparatus 100 in a step S907. If the pending abnormal condition is reset or resolved by the power reactivation, the image forming apparatus 100 transmits a SC removal call to the management apparatus 102 in a step S908. The management apparatus 102 then returns a corresponding response back to the image forming apparatus 100 in a step S909. If the management apparatus 102 receives the power activation report from the SC call originating source within a first predetermined amount of time t1 and the SC removal call corresponding to the SC call within a second predetermined amount of time t2, it is determined that the abnormal condition of the SC call at the image forming apparatus has been reset or resolved due to the user initiated power reactivation. As a result of the above determination, the corresponding SC call information stored in the abnormality queue is removed in a step S910. For the above described removal process, the center operator instruction is not necessary, and the center operator does not need to work on the abnormality condition that is handled by the user side within the predetermined amount of time.

Furthermore, certain abnormal conditions are reset without the power reactivation. When a corresponding SC removal call is received for the SC call within the first predetermined amount of time t1 without receiving the power reactivation report, it is similarly determined that the corresponding abnormal condition has been resolved and the stored SC call information is removed from the abnormality information queue. The first predetermined amount of time t1 is time after the SC call reception during which the SC removal call or the power activation report is waited without notifying the center operator of the abnormality occurrence. The second predetermined amount of time t2 is time after the power activation report reception during which the SC removal call is waited. If the SC removal call is not received within the first predetermined time t1 after the SC call reception, the SC removal call is still expected within the second predetermined time t2 after the power activation has been received. For this reason, it is preferred that the above described two-tier waiting time is provided. The predetermined time is later described in detail.

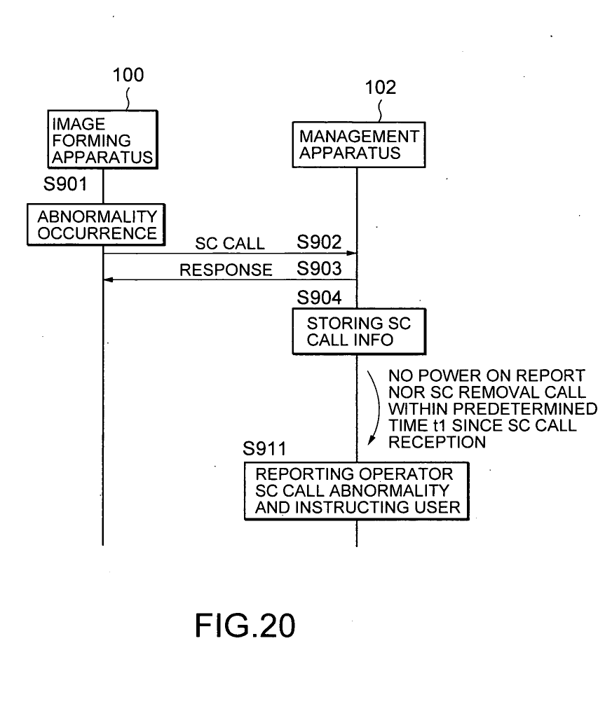

Now referring to FIG. 20, a timing chart illustrates exemplary sequence of events after the SC has occurred and the corresponding SC is not removed. In a step S901, an abnormal condition occurs. The image forming apparatus 100 reports the abnormality information on the SC occurrence via SC call to the management apparatus 102 in a step S902. The management apparatus 102 returns a corresponding response result in a step S903 and stores the SC information contained in the SC call in the abnormality information queue in the database 605 in a step S904 as already described with respect to FIG. 11. After the SC call reception and the subsequent predetermined time t1, since no SC removal call is received for the corresponding SC call, it is determined that the abnormality has not been resolved. It is further determined that the support is needed from the management center since the user side has not been able to deal with the abnormal condition.

In a step S911, the abnormality occurrence of the SC call is notified to the center operator, and the operator is instructed to contact the user. The notification is made by displaying the abnormality information on the display unit of the operator terminal 604 or generating audible alarm sound. Upon receiving the above notification, the center operator contacts the user via telephone to collect the detailed information on the situation. The center operator then provides instructions for dealing with the situation and possibly makes arrangements for dispatching the maintenance personnel. During the notification, it is also preferred that the center operator is notified about the lack of the user attempt by the power activation. In certain situations, the center operator instructs the user to attempt the power activation for resolving the abnormality condition so that the response is promptly completed.

Furthermore, although the predetermined time t1 is always constant in one preferred embodiment, the time t1 value is adjusted based upon the user situation in an alternative embodiment. As described with respect to FIG. 20, the predetermined time t1 matches with the time from the abnormality occurrence to the contact of the user. There are various kinds of users for the image forming apparatus 100, and the types include users who can handle some abnormal conditions without support, users who need support for simple abnormal conditions, users who desire prompt support, users who feel annoyed by frequent contacts and users who need smooth handling according to the contract or established relations. Since the proper amount of time between the abnormality occurrence and the customer contact varies from one user to another user, any type of the users needs to be accommodated. For example, the database 605 made to function as the user information storage means to store a customer database, and the predetermined time t1 is determined by referring to the user information that is stored in the customer database.

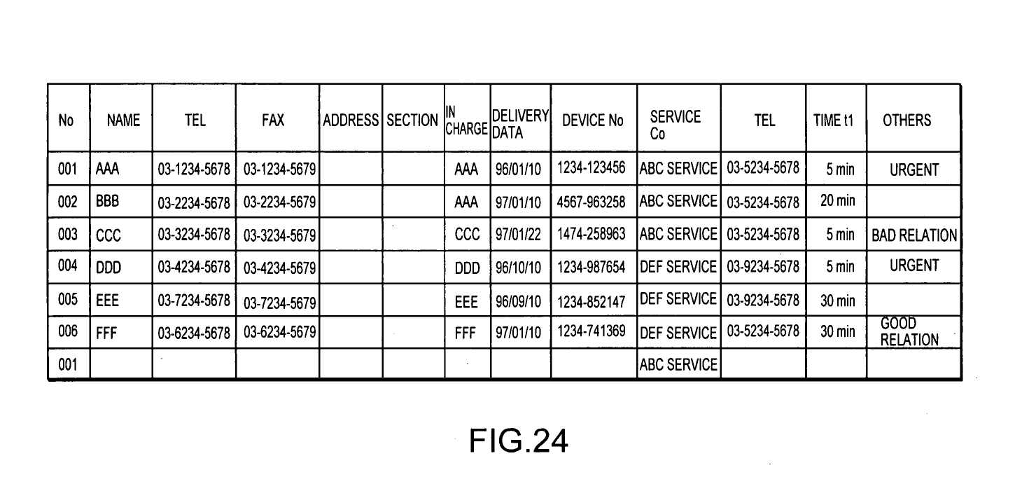

FIG. 24 is a table illustrating an exemplary customer database. The customer database usually includes the device number information of the image forming apparatus 100 that a particular customer uses in addition to the customer contact information. The customer contact information includes a name, a telephone number, a fax number, an address, a relevant section and a person in charge. Furthermore, the customer database includes a name of a service company and a corresponding telephone number as well as other information. The customized predetermined time t1 is also stored in the customer database for each customer or user. At the time when the SC call is received, the customized predetermined time t1 is obtained from the customer database based upon the device number information of the user in the SC call SOAP message and the predetermined time t1 value is accordingly established.

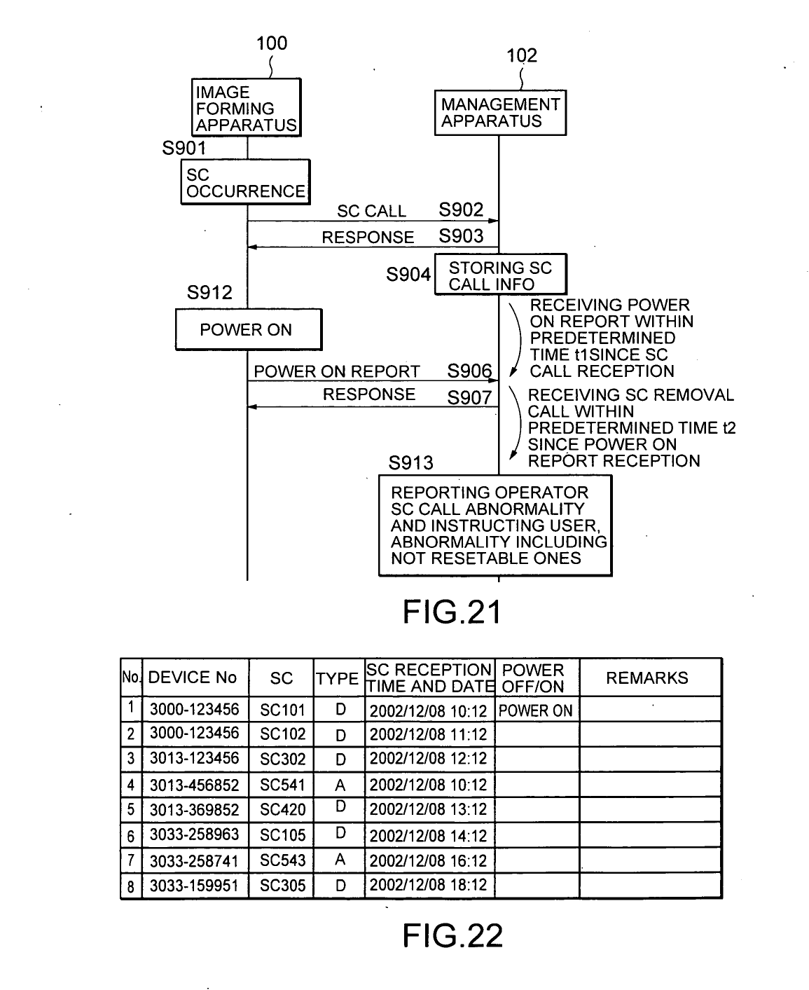

Now referring to FIG. 21, a timing chart illustrates exemplary sequence of events after the SC has occurred and the corresponding SC is not removed even though the power activation has been attempted. In a step S901, an abnormal condition occurs. The image forming apparatus 100 reports the abnormality information on the SC occurrence via SC call to the management apparatus 102 in a step S902. The management apparatus 102 returns a corresponding response result in a step S903 and stores the SC information contained in the SC call in the abnormality information queue in the database 605 in a step S904 as already described with respect to FIG. 11. The power supply is reactivated at the image forming apparatus 100 in a step S912, but the pending abnormality of the SC call is not reset by the power manipulation. The image forming apparatus 100 transmits the power activation report to the management apparatus 102 in a step S906.

In turn, the management apparatus 102 returns a corresponding response to the image forming apparatus 100 in a step S907. Although the power activation report is received within the predetermined time t1 at the management apparatus 102, no SC removal call is received within the predetermined time t2 since the reception of the power activation report. It is then not determined that the abnormal condition corresponding to the pending SC call has been removed. Furthermore, it is also determined that the pending abnormal condition cannot be reset by the power reactivation. For this reason, it is further determined that the support from the management center is necessary in a step S913. The abnormality occurrence of the SC call is notified to the center operator, and the center operator is instructed to contact the corresponding customer. The above notification is provided in the substantially same manner as described with respect to FIG. 20. Upon receiving the notification, the center operator contacts the user via telephone and collects the detail information on the situation. The center operator then instructs the customer to deal with the situation and makes arrangement for dispatching maintenance personnel. During the notification, it is also preferred that the center operator is notified about the lack of the user attempt by the power activation. Since the power reactivation often resets the pending abnormal condition, the center operator first instructs the customer to switch off and on the power in many instances. However, if the user has already attempted the power switch off, the proper center operator notification prevents from retrying a wasteful power activation procedure and damaging the user impression.

Still referring to FIG. 21, the second predetermined time t2 is determined in the following manner. Since the second predetermined time t2 is determined based upon the reception of the power activation report, when the power activation report is promptly received after the SC call reception, the second predetermined time t2 elapses since the power activation report before the first predetermined time t1 elapses since the SC call reception. In the above illustrated situation, one preferred process waits to notify the center operator of the abnormal condition until the first predetermined time t1 elapses after the SC call reception. However, since the abnormal condition has not been resolved after the power reactivation, it is expected that the user cannot easily deal with the situation, the center operator is notified without a wait in the preferred process after the second predetermined time t2 has elapsed after the power activation report. Although the second predetermined time t2 is always consistently set to a single value, a proper amount of time varies depending upon the device type.

When the abnormal condition is resolved in the image forming apparatus 100, the time necessary to transmit the SC removal call after the power activation report transmission is set in the second predetermined time t2. Although this time is a time difference between the SCS 306 initialization time and the engine unit initialization time, the time may depend upon the environment. For this reason, the time may be set a little longer than the generally considered above time. In the above described manner, for each of the image forming apparatus 100, a proper amount of waiting time is established. When the abnormality is not resolved by the power activation, a prompt user contact is implemented. For example, the database 605 made to function as the device information storage means to store a device database, and the second predetermined time t2 is determined by referring to the device information that is stored in the device database.

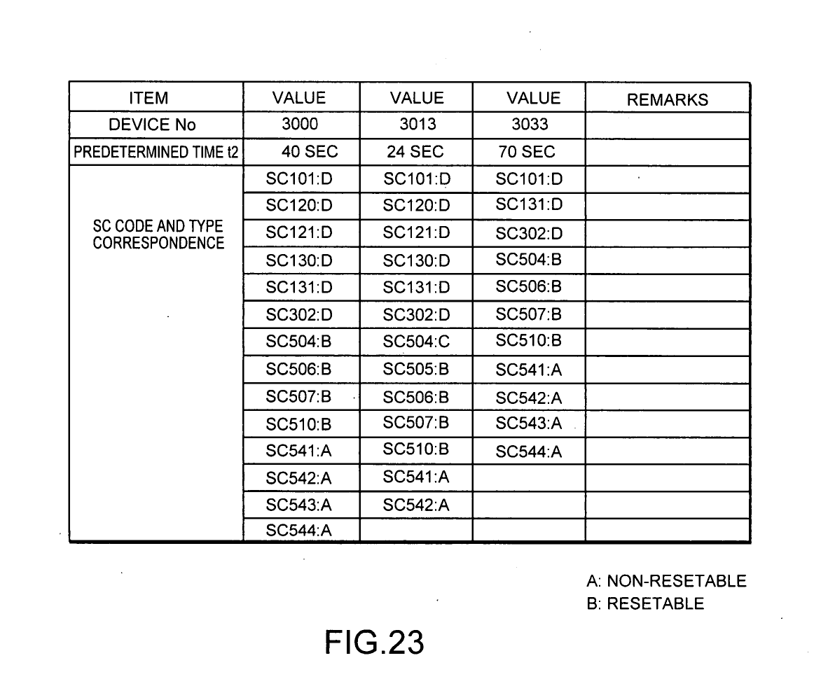

Now referring to FIG. 23, a table illustrates one exemplary device type database. The device database stores the device number and the corresponding proper second predetermined time t2 for each device. When the SC call is received, the corresponding second predetermined time t2 is obtained based upon the device number as a key in the device number information in the SC call SOAP message. The correspondence for the SC code and type will be later described. The above data management operation will be described with respect to the following figures. To simplify the description, it is assumed that after an abnormal condition occurs in one image forming apparatus, no new abnormal condition does not occur until the first abnormal condition is resolved. The process for handling a plurality of normal conditions will be later described with respect to an alternative embodiment.

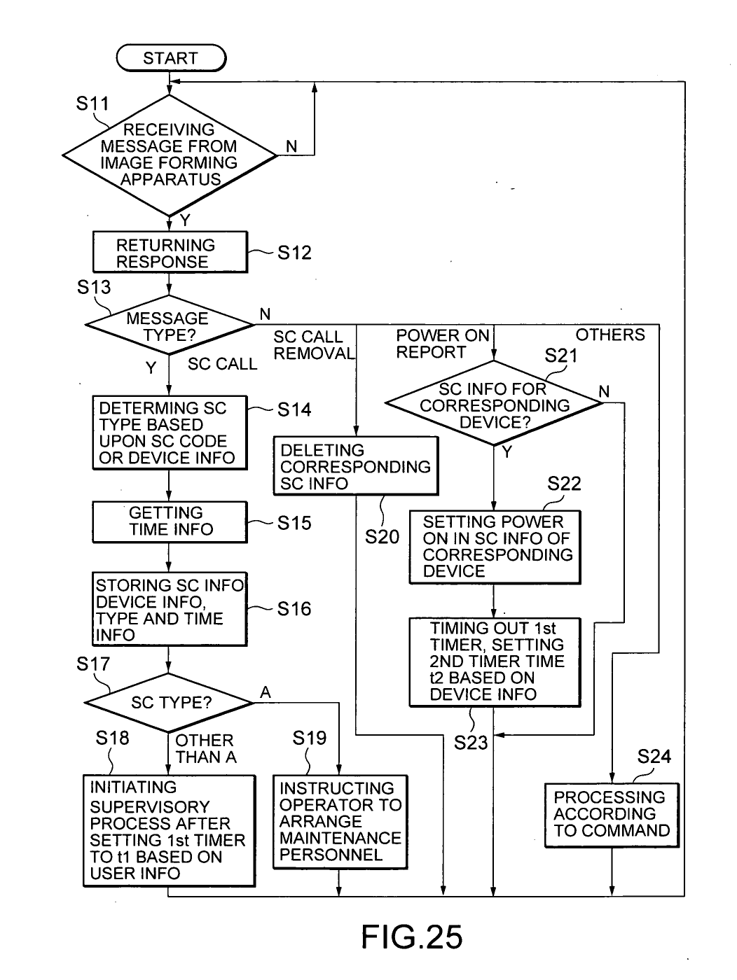

Now referring to FIG. 25, a flow chart illustrates steps involved in a portion of the preferred process in response to the information received from the image forming apparatus according to the current invention. As expected, the operational steps that are not directly relevant to the current invention are omitted from the illustration. While the CPU in the management apparatus 102 manages the image forming apparatus 100, a predetermined set of software programs is executed to process as delineated in the flow chart of FIG. 25. Although START is shown in the flow chart for convenience, no END is shown as the process is assumed to be continuous. In a step S11, the preferred process is waiting until a message is received from any one of the image forming apparatus 100 via the intermediate apparatus 101. The message includes a call, a report, and a SOAP message corresponding to a predetermined command. From the intermediate apparatus 101, the message is sent as a HTTP message including one of the SOAP messages. If it is determined in the step S11 that a message is received, a response is returned in a step S12.

In a step S13, a type of the received message is determined. Although the corresponding step in the flow chart is illustrated as a regular YES or NO decision, it should be interpreted as a case statement as in the C language. In other words, the type is determined to be one of the four possibilities. If it is determined in the step S13 that the type is the SC call, the preferred process proceeds to a step S14. In the step S14, the SC type information is obtained from the database 605 based upon the device number in the SC call SOAP message and the SC code. The SC type is assigned to an occurred abnormal condition based upon urgency and the degree of effect on the device operation.

For example, “Type A” represents a SC that cannot be solved by a user to use the apparatus and is displayed on the character display unit of the operation panel 205 to prohibit the use. “Type A” includes events that does not allow “SC reset” by the management apparatus 102 and abnormal conditions that may cause fire. “Type A” needs immediate attention. The SC reset from the management apparatus cannot reset these abnormal conditions. For example, Type A SC is related to a fixation unit.

“Type B” represents a SC that does not allow the use of a specific predetermined function in which abnormality is detected. In normal use, a SC is not displayed on the character display unit of the operation panel 205. However, only when the specified function in which abnormality is detected is selected, the SC is displayed on the character display unit. An exemplary type B SC occurs when a duplex mode is selected while a duplex unit is in an abnormal condition.

“Type C” represents a SC that is internally logged without any display on the character display unit of the operation panel 205. For example, when communication becomes impossible, the SC is the “type C.”

“Type D” represents a SC that makes the SC display on the character display unit of the operation panel 205 so as to prohibit the use of the image forming apparatus. However, the type D SC can be solved by an OFF/ON operation in which the main power supply of the apparatus is temporarily turned OFF and then turned ON again. Alternatively, the apparatus is reset by an operation of the software power supply key or a reboot key. There is also a case where the SC is detected again even after the main power supply is turned OFF and ON and the SC does not seem to be solved. For example, motor malfunction corresponds to the “type D.”

The correspondence between the above types and the SC code indicative of the type is stored at a predetermined storage area of the NV-RAM 202 of the image forming apparatus 100. The image apparatus 100 responds based upon the type. Since the type information is stored in the SC call SOAP message, the image forming apparatus 100 directly refers to the SOAP message and obtains the type information. Without the above function in the image forming apparatus 100, instead the device database stores the corresponding relations between the SC types and codes for each device so that the SC type information is obtained based upon the SC code as a key.

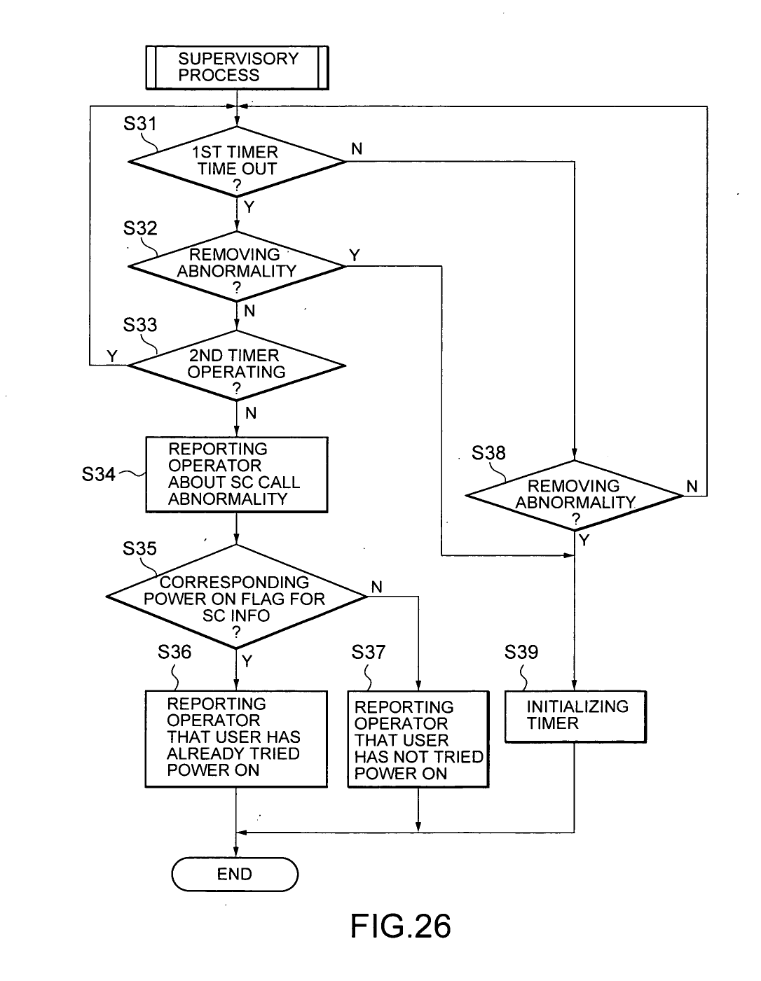

Referring back to FIG. 25, the preferred process proceeds to a step S15 after the step 14 has been completed. In the step S15, time and date information is obtained from an internal timer in order to use it as the SC call reception time. In a step S16, the abnormality information in the SC call is stored in the abnormality information queue along with the device number, the SC type and the reception time. The stored information is an object of the information management operation. In a step S117, it is determined whether or not the SC type is Type A. If it is determined in the step 17 that the SC type is not Type A, the preferred process proceeds to a step S18. By referring to the user information in the customer database, the first predetermined time t1 is set in a first timer for the image forming apparatus user who corresponds to the received SC call. Then, the preferred process continues onto the supervisory handling as illustrated in FIG. 26. The supervisory handling is separately performed for each image forming apparatus as specified by the received SC call. On the other hand, if it is determined in the step 17 that the SC type is Type A, the preferred process proceeds to a step S19. Since Type A is an abnormal condition that does not require to wait for the user handling, a center operator is immediately notified of the occurrence of the abnormal condition and maintenance personal is arranged for dispatch. After the step 18 or 19, the preferred process returns to the step S11 to wait for a message again.

Still referring to FIG. 25, if it is determined in the step S13 that the message is a SC removal call, the preferred process proceeds to a step S20. Based upon the SC removal call, it is determined that the existing abnormality has been reset or removed, and the corresponding abnormality information is removed from the abnormality queue. Along with the removal, if the supervisory handling is taking place, this handling is terminated as will be later described. The step S20 is independent of the supervisory handling and is always performed regardless of timing of the SC removal call reception. In other words, when the SC removal call is received in such timing as already described with respect to FIG. 19, the SC information is deleted without any involvement of the center operator. When the SC removal call is received in such timing as already described with respect to FIG. 20 or 21, the center operator is notified of the abnormal condition. After the abnormal condition is removed either by the instructions from the center operator or the repair by the maintenance personnel, when the SC removal call is received, the SC information is similarly deleted since there is no difference in the reset of the abnormal condition. For this handling, it is not particularly relevant whether or not the SC removal call is received within the second predetermined time t2 since the power activation report. Without deleting the SC information, the SC information is alternatively kept with the notation that the abnormality has been reset. After the step S20, the preferred process returns to the step S11 to wait for another message.

Still referring to FIG. 25, if it is determined in the step S13 that the message is a power activation report, the preferred process proceeds to a step S21. It is determined in a step S21 whether or not the corresponding SC information is stored in the abnormality information queue. The SC information corresponds to the device number that is contained in the power activation SOAP message. If it is determined in the step S21 that the corresponding SC information is stored in the abnormality queue, the preferred process proceeds to a step S22. The power on flag is set in the corresponding SC information. Furthermore, in a step S23, if the supervisory handling is being performed for the SC information, the first timer is timed out, and a second timer is set to the second predetermined time t2 by referring to the device database. The center operator is subsequently notified of the occurrence of the abnormal condition. If the above notification is made after the predetermined time t1 has elapsed since the SC call reception, the first timer is not made to be timed out. After the step S23, the preferred process returns to the step S11 to wait for another message. On the other hand, if it is determined in the step S21 that the corresponding SC information is not stored in the abnormality queue, the preferred process also returns to the step S11 to wait for another message. Lastly, if it is determined in the step S13 that the message is classified as others, the preferred process proceeds to a step S24. A corresponding handling is performed in the step S24 for the command that is contained in the received message. The command includes a call or a report. Then, the preferred process also returns to the step S11 to wait for another message.

Now referring to FIG. 26, a flow chart illustrates steps involved in the preferred process of supervisory handling according to the current invention. The supervisory handling is initiated in the step S18 as already described with respect to FIG. 25. The supervisory handling is also performed by the CPU to execute the necessary software programs by of the management apparatus 102. In the supervisory handling, in a step S31, it is determined whether or not a first time has been timed out. If it is determined in the step S31 that the first timer has not been timed, the preferred process proceeds to step S38. It is determined in the step S38 whether or not the abnormal condition has been removed. If it is determined in the step S38 that the abnormal condition has not been removed, the preferred process returns to step S31 to repeat the supervisory handling. That is, the supervisory handling waits by repeating the steps S31 and S38 until the abnormal condition has been resolved or the first timer is timed out. To determine whether or not the abnormal condition has been resolved, it is found whether not the SC information for the supervisory handling remains in the abnormality information queue. Thus, when the SC information is deleted in the step S20 of FIG. 25 after the SC removal call is received, it is determined that the abnormal condition has been removed. When it is determined that the abnormal condition has been reset before the first timer is timed out or within the first predetermined time t1 since the SC call reception, the supervisory handling proceeds to a step S39 from the step S38. In the step S39, the timer is cleared or initialized, and the supervisory handling terminates. In this case, the center operator is not notified of the occurrence of the abnormal condition.

On the other hand, when the first timer is timed out before the abnormality is reset, the supervisory handling proceeds to a step S32 from the step S31. The above progression includes a situation where the step S23 in FIG. 25 is timed out. In the step S32, it is also determined whether or not the abnormality of the SC call has been removed as in the step S38. At the time when the supervisory handling first moves to the step S32, since the corresponding abnormality is not resolved, the supervisory handling proceeds to a step S33. In the step S33, it is determined whether or not the second timer is operating. If it is determined in the step S33 that the timer is operating, the supervisory handling returns to the step S31 to repeat the steps S31 through S33. The second timer is activated in the step S23 in FIG. 25 upon the reception of the power activation report. Unless the second timer is timed out, the second timer is treated as not-in-operation when the power activation report is not received before the first timer is timed out and the second timer is not initiated. That is, the second timer is in operation during a period of the second predetermined time t2 after the power activation report is received, and the step S33 handling is in hold during the same period. While the steps S31 through S33 are repeated, if the SC removal call is received before the second predetermined time t2 elapses since the reception of the power activation report, it is determined that the abnormal condition has been removed and the supervisory handling proceeds from the step S32 to the step S39. The timer is initialized in the step S39, and the supervisory handling is terminated. In this case, the center operator is not notified of the occurrence of the abnormal condition.

Still referring to FIG. 26, if it is determined in the step S33 that the second timer is not in operation, the supervisory handling proceeds to a step S34. It is determined that the abnormal condition has been removed within the first predetermined time t1 since the SC call reception or within the second predetermined time t2 since the power activation report reception. In the step S34, the center operator is notified of the occurrence of the abnormal condition. Then, in a step S35, it is determined whether or not the power activation flag is on for the corresponding SC information. If the power activation flag is on, it means that the abnormal condition has not been removed based upon the power activation report that is received within the first predetermined time t1 since the SC call reception and within the second predetermined time t2 since the power activation report. That is, the SC removal call is not received. It means that the abnormal condition for the SC call is a type of abnormality that is not reset by the power activation. The supervisory handling proceeds to a step S36 and notifies the center operator of the above situation where the user has already attempted the power activation. The supervisory handling terminates the process. On the other hand, if it is determined in the step S35 that the power activation flag is not on, it means that the power activation report has not been received within the first predetermined time t1 after the SC call reception. The supervisory handling proceeds to a step S37, where the center operator is notified that the user has not yet attempted the power activation. The supervisory handling terminates the process. The above described process and handling routines as illustrated in FIGS. 25 and 26 are performed for the management operations as described with respect to FIGS. 19 through 21.

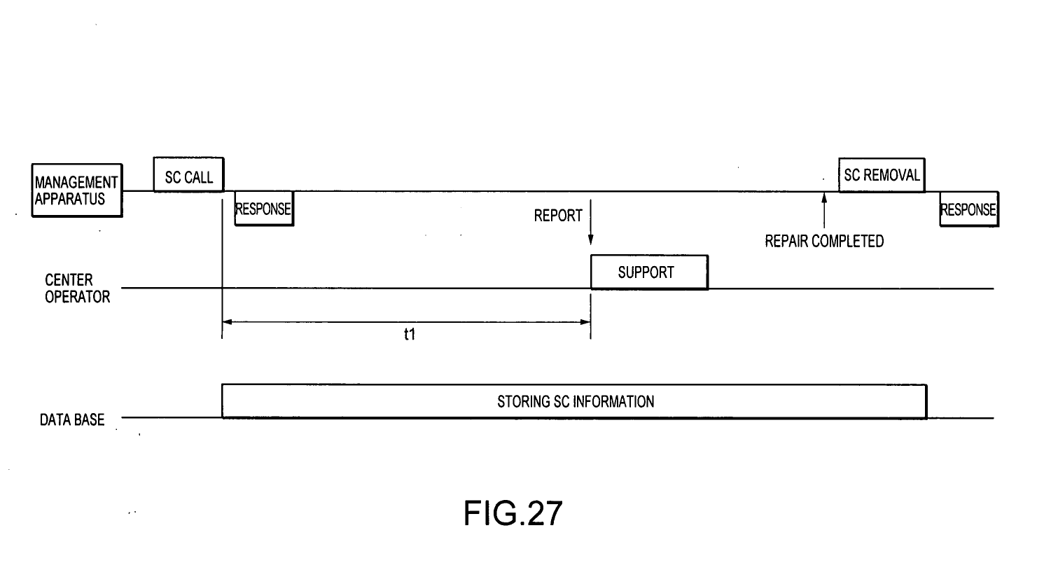

Now referring to FIGS. 27 through 30, timing charts illustrate concrete examples of management operations according to the current invention. In the timing charts, the management apparatus column indicates the corresponding timing of the messages that the management apparatus 102 receives and transmits. The center operator column indicates the corresponding timing of the support that the center operator performs in response to the abnormality occurrence report from the management apparatus 102. The database column indicates the period for storing the SC information in the abnormality information queue. FIG. 27 is a timing chart illustrating an exemplary situation that nothing in particular has been done after abnormality occurs and the abnormal condition has not been removed. The management apparatus 102 has received neither the power activation report nor the SC removal call within the predetermined time t1 since the SC call reception. At this point, the management apparatus 102 notifies the center operator of the occurrence of the abnormal condition. In response to the notification, the center operator provides support such as telephone contacts and repair arrangements. After the repair is completed, the SC removal call is transmitted from the image forming apparatus 100. When the management 102 receives the SC removal call, it assumes that the abnormal condition is reset and removes the SC information stored in the abnormality information queue.

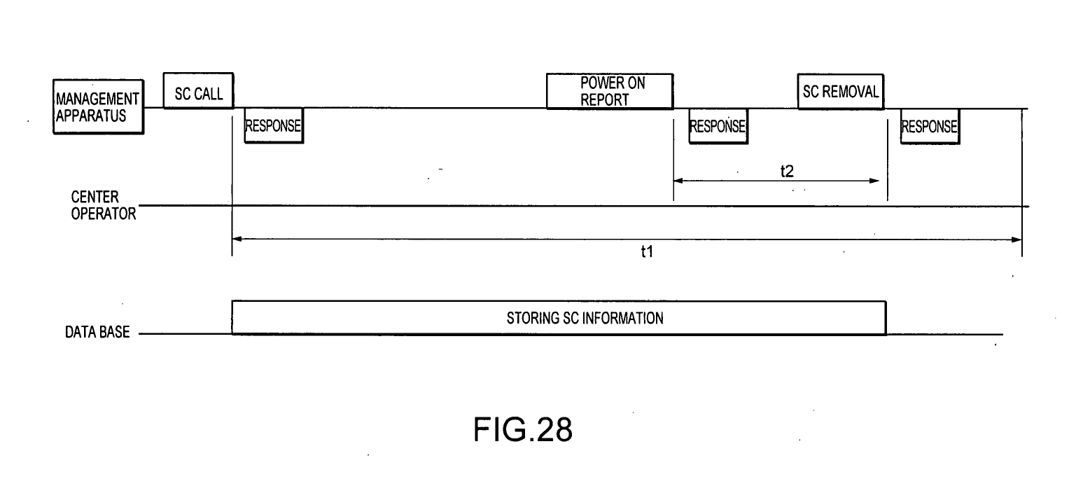

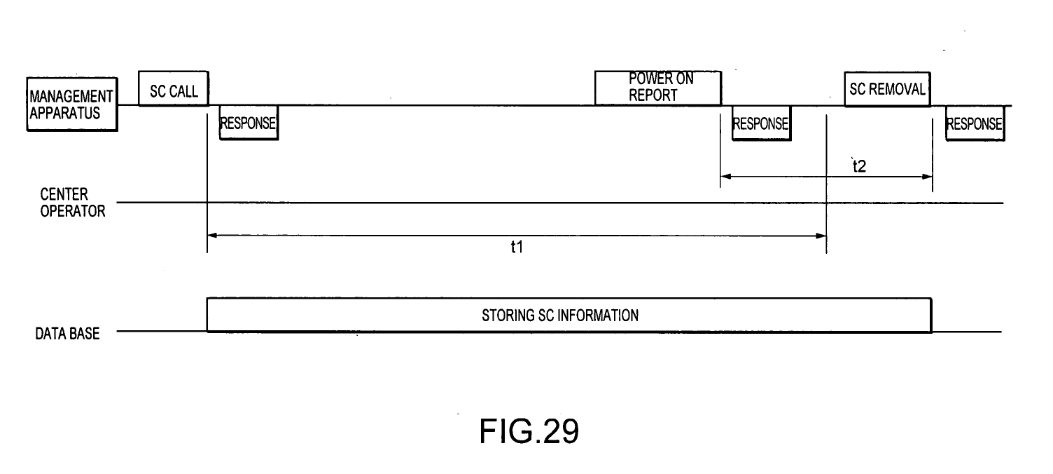

FIGS. 28 and 29 are both timing charts illustrating an exemplary situation that after abnormality occurs, the abnormal condition has been removed by the power reactivation. In FIG. 28, the management apparatus 102 has received the power activation report and the SC removal call within the predetermined time t1. Because of the reception, the center operator is not notified of the occurrence of the abnormal condition, and the SC information is removed after the SC removal call is received. In FIG. 29, the management apparatus 102 does not receive the SC removal call within the first predetermined time t1 since the SC call reception, but does receive the power activation report within the same time period. Thus, if the abnormal condition has been removed by the power activation, the SC removal call is potentially received within a second predetermined time t2 since the power activation report. During the same period, the center operator is not notified of the occurrence of the abnormal condition, and the SC removal call is waited. In this example, the SC removal call is received during the above period, the SC information is deleted without notifying the center operator of the occurrence of the abnormal condition.

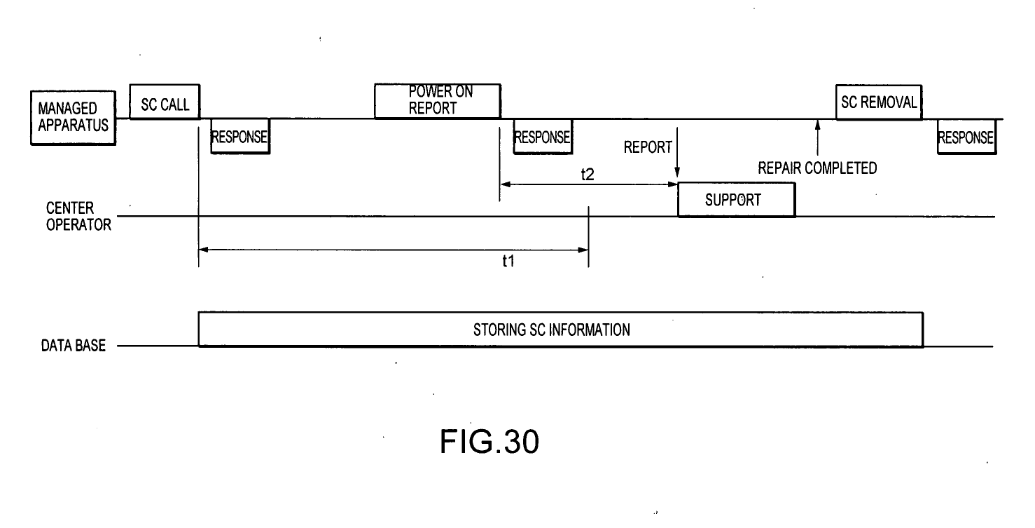

FIG. 30 is a timing chart illustrating an exemplary situation that after abnormality occurs, the abnormal condition has not been removed even after the power reactivation. In this case, since the management apparatus 102 receives the power activation report within the first predetermined time t1 since the SC call reception, it is the same in FIG. 29 to wait for receiving the SC removal call after the power activation report until the second predetermined time t2 elapses. However, in the above example, since the SC removal call is not received within the period, the center operator is notified of the occurrence of the abnormal condition after the period elapses. In response, the center operator performs the support. After the repair is completed, the SC removal call is transmitted from the image forming apparatus 100. When the management 102 receives the SC removal call, it assumes that the abnormal condition is reset and removes the SC information stored in the abnormality information queue.

In the above, examples are shown for the preferred process when no new abnormal condition occurs in the same image forming apparatus after an initial abnormal condition occurs and before the initial abnormal condition is removed. In the following, an alternative process will be described for handling a plurality of abnormal conditions occurs in an overlapping manner.

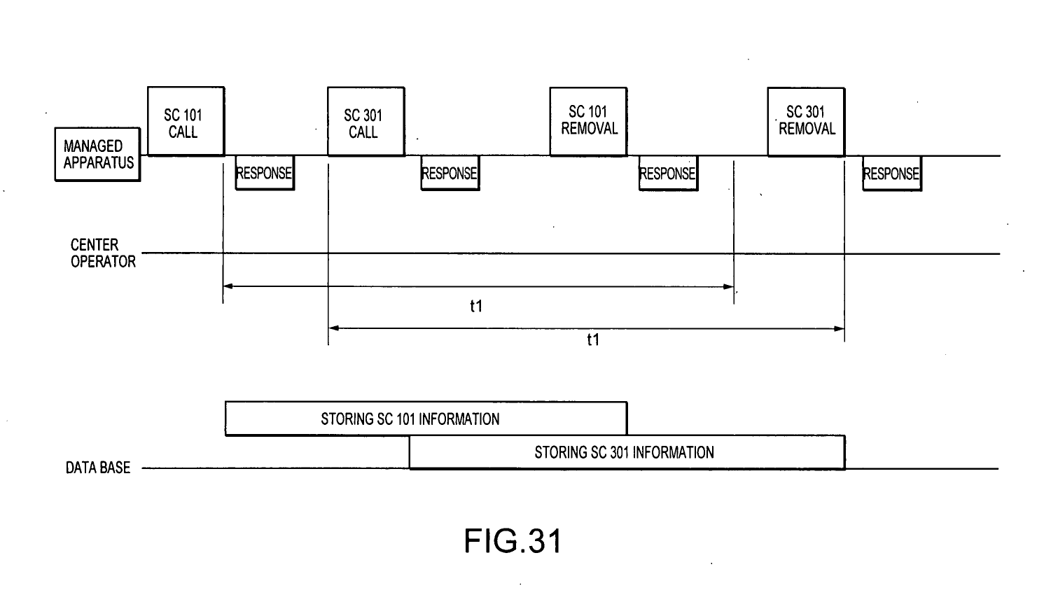

Now referring to FIG. 31, a timing chart illustrates a first exemplary management operation that after an initial abnormal condition, a new abnormal condition occurs before the initial abnormal condition is removed. In this example, before the abnormal condition corresponding to the initial SC call is removed, if another SC call is received for a separate abnormal condition from the same image forming apparatus, the management process as illustrated in FIG. 26 is separately performed for each of the SC calls. At the time when the management apparatus 102 receives the SC 101 call for the SC code 101, the SC information for the SC call is stored in the abnormality information queue. Since the corresponding SC 101 removal call is received within the first predetermined time t1, the SC information is deleted without notifying the center operator of the occurrence of the abnormal condition for the SC code 101. At the time when the management apparatus 102 receives the SC 301 call for the SC code 301, the SC information for the SC call is stored separately from that of the SC 101 in the abnormality information queue. Since the corresponding SC 103 removal call is received within the first predetermined time t1, the SC information is deleted without notifying the center operator of the occurrence of the abnormal condition for the SC code 301. If the SC 103 removal call is not received within the predetermined time t1 after receiving the SC 301 call, the center operator is notified of the occurrence of the abnormal condition for the SC code 301. As shown in FIG. 22, the device number and the SC code are stored in the abnormality information queue. The above management is easily accomplished by the stored information. However, if there is a plurality of the SC information for the corresponding device number in the step S22 of FIG. 25, all of the power activation flags are set. Similarly, the step 23 is performed on all of the SC information.

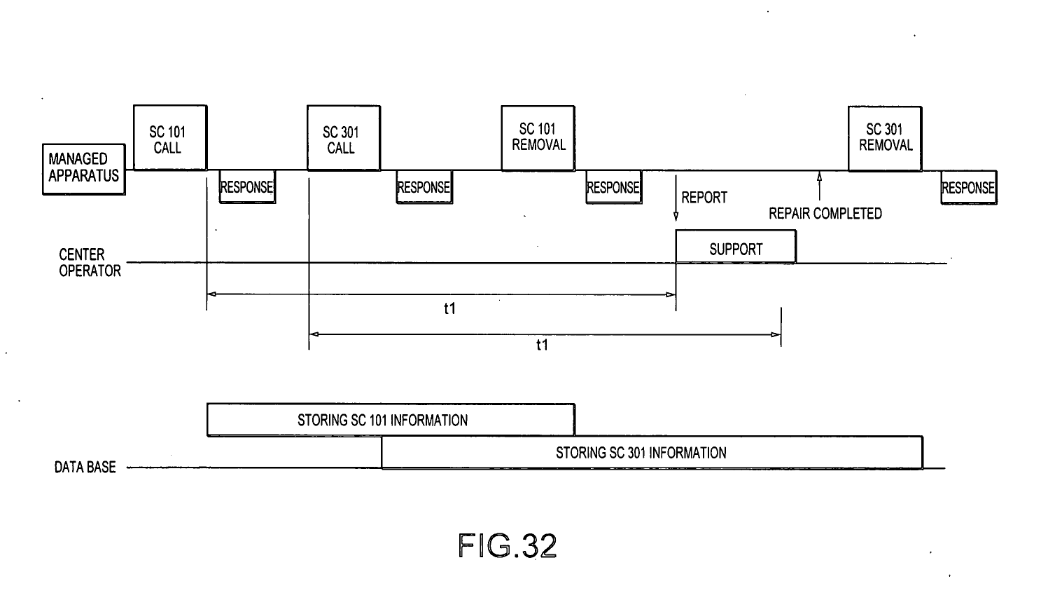

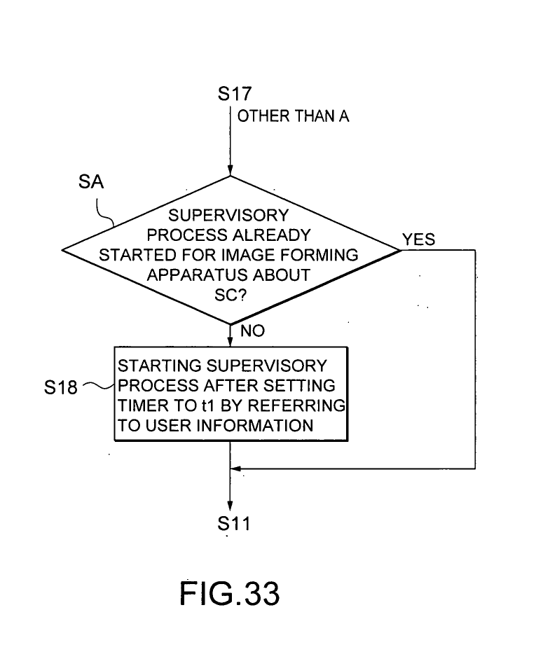

Now referring to FIG. 32, a timing chart illustrates a second exemplary management operation that after all abnormal conditions are removed, it is determined that the abnormal condition has been removed. In this example, the management process as shown in FIG. 26 is performed for each image forming process. When every abnormal condition is removed, it is then determined in the step S22 or S28 of FIG. 26 whether or not the abnormal condition is removed. In this case, in the process as shown in FIG. 25, a step SA as shown in FIG. 33 is added between the steps S17 and S18. If the supervisory handling is already started for the image forming apparatus for the received SC call, no new supervisory handling is initiated and the current supervisory handling is continued for a new abnormal condition. As in the example as shown in FIG. 32, at the point when the SC 101 call or the SC 301 call are received, the respective SC information is stored in the abnormal information queue as already illustrated in FIG. 31.

However, at the point when the SC 101 removal is received within the first predetermined time t1 after receiving the SC 101 call, the SC information is deleted without notifying the center operator of the occurrence of the abnormal condition for the SC code 101. At this timing, since the abnormal condition for the SC code 301 is not removed, the timer is continued to count. Subsequently, since the SC 301 removal is not received at the point when the first predetermined time t1 has elapsed after the SC 101 call, the center operator is notified of the occurrence of the abnormal condition. However, the abnormal condition to be reported is only the abnormal condition for the SC code 301 that is remaining at the report time. After the repair is completed in response to the support by the center operator, the SC 301 removal is transmitted from the image forming apparatus, and in response, the management apparatus 102 deletes the SC information in the abnormality information queue as in the example illustrated in FIG. 27. Even when the kind of the abnormality changes in the middle, since there is no difference at the user side that the abnormal conditions continue in the image forming apparatus, it is effective to determine whether or not the abnormal condition has been removed for each device. In the step S22 of FIG. 25, if there is a plurality of the corresponding SC information for the device number, all of the power on flags are reset. In the step S23, the process is performed on the SC information only for image forming apparatus.

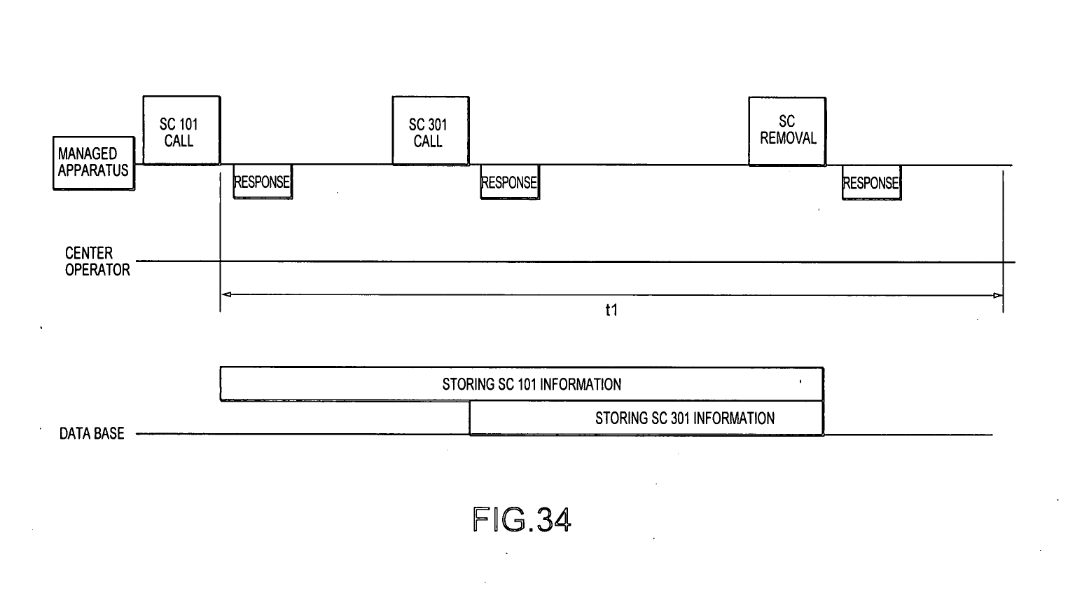

Furthermore, to determine whether or not the abnormal condition has been resolved for each device, there is no need for matching the SC removal call with the SC call. At the time when all of the abnormal conditions are resolved, a single SC removal call is performed as shown in the example in FIG. 34. In this case, timing is not relevant as to when the abnormal conditions for the SC code 101 and the SC code 301 are resolved. At the point when all of the abnormal conditions have been resolved, the SC removal call is transmitted from the image forming apparatus 100. If the SC removal call is received within the first predetermined time t1 since the first SC call or SC 101 call, the SC information is deleted without notifying the center operator of the occurrence of the abnormal condition. By the above described operation, since the number of transmissions for the SC removal call is reduced, the communication traffic and the processing load are also reduced. In the examples as illustrated in FIGS. 31 through 34, the description on the power activation report is omitted. However, the management using the power activation report as described in the previous examples is also used in the current management operational example.

As clearly understood from the above description, the abnormal condition information is managed by the SC call or abnormality information and the SC removal call or abnormality removal information from the image forming apparatus 100. Even if the firewalls are installed between the image forming apparatus 100 and the management apparatus 102, the management apparatus 102 monitors in real time the occurrence and removal of the abnormal conditions at each of the image forming apparatuses 100 so that proper and efficient management is accomplished. Even if the SC call and the corresponding SC removal call are received, it is determined that the abnormal condition has been resolved for the SC call. Based upon the above scheme, the management of the abnormality information is facilitated. If the content of the SC call and the SC removal call contains different information based upon the type of the abnormal condition, the resolution of the abnormal conditions is determined for each of the types of the abnormal conditions to provide a refined process. At the proper timing as described with respect to FIGS. 19 through 21, the center operator is notified of the occurrence of the abnormal condition so that he or she contacts a customer also at a proper timing to deal with the abnormal condition. By not notifying the center operator prior to the above notification, if the corresponding abnormal condition has been removed before the notification, the center operator performs no tasks to reduce a necessary amount of labor.

Using the power activation report for the management operation, if the SC removal call is not received within the second predetermined time t2 after the power activation report from the image forming apparatus that originated the SC call, it is determined that the abnormal condition is not reset by the power activation. The support from the management center is provided by confirming the status of the abnormal condition to some extent. By providing the center operator with the above information, proper handling for the customer support is offered without waste at the time of customer contact. Furthermore, if the first predetermined time t1 is set based upon the user information, the customer handling is customized based upon the user situation. If the second predetermined time t2 is set based upon the device information, the handling is customized based upon the device operational hours. The SC call, the power activation report and the SC removal call are written in the structured language., The data is more flexibly utilized, and the design and change of the data format is easily accomplished.

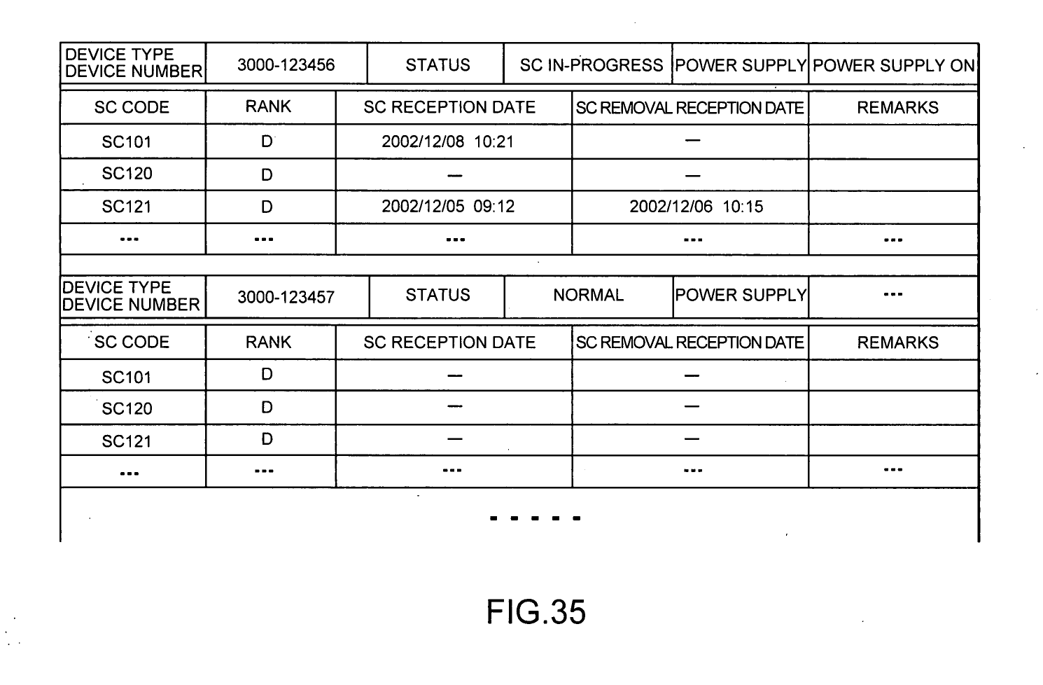

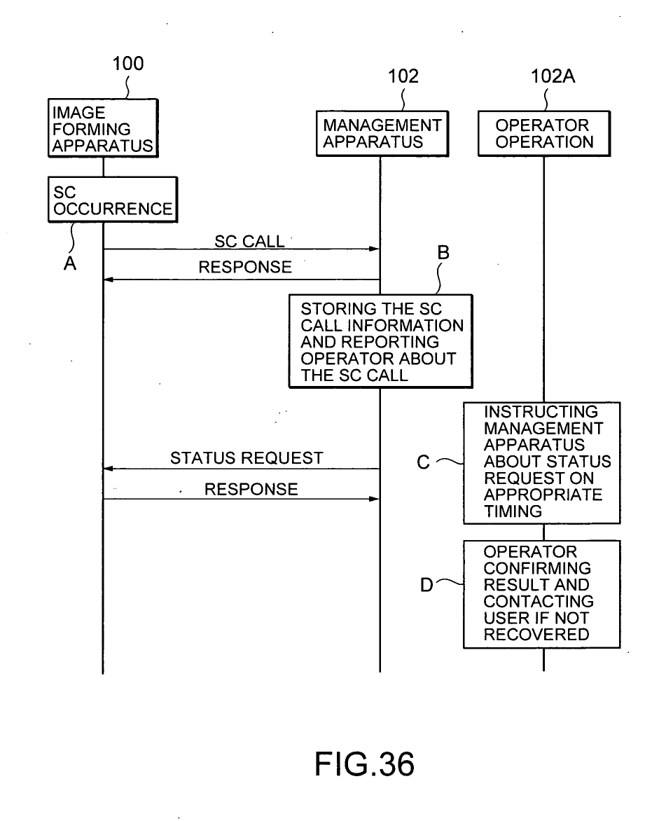

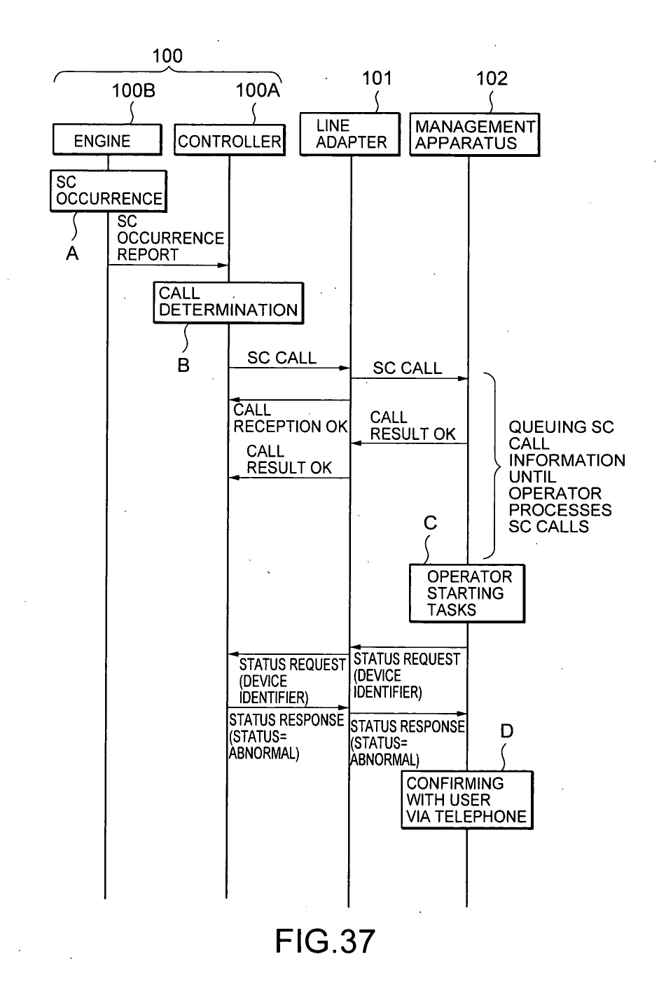

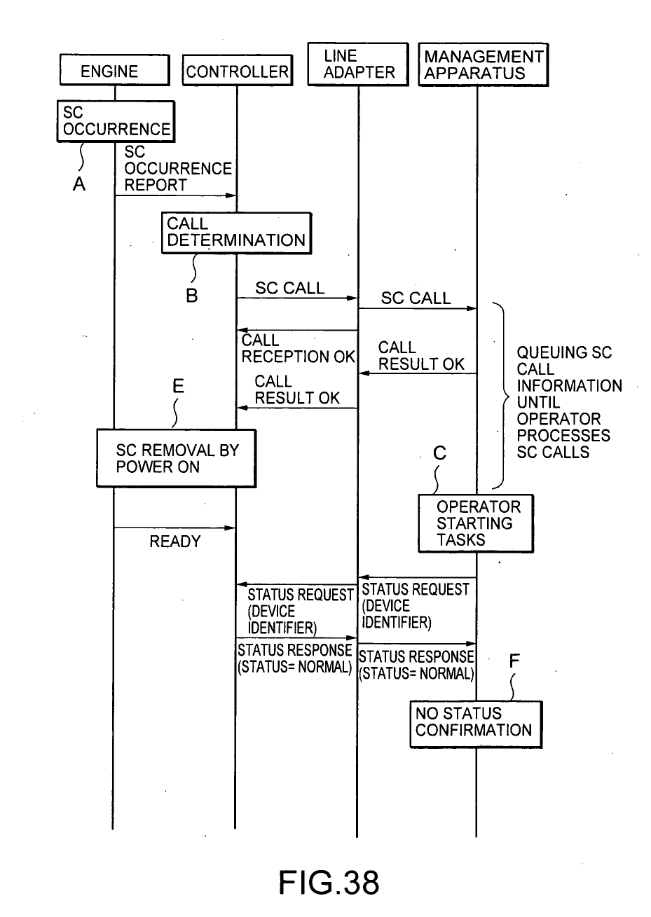

Now referring to FIG. 35, a table illustrates an exemplary format for the management of the abnormal condition information that is different from the queue style as shown in FIG. 22. In this example, a table is prepared for each of the image forming apparatus and stores a device number, abnormality status information, power activation flag information, the rank by the SC code and the reception time and date. Based upon the above management, the management of the abnormality occurrence is facilitated by the abnormality type. An example has been described that the occurrence report of the abnormal condition is reported to the center operator or the terminal 604 of the management apparatus 102. In an alternative embodiment, the occurrence of the abnormal condition is reported to the maintenance personnel by enabling the communication with the portable communication terminal that the maintenance personnel carries or the terminal for the management apparatus 102, where maintenance personnel is immediately available. When the user is not able to reset the abnormal condition, the maintenance personnel is promptly dispatched to the customer.

In the above preferred embodiments, the description has been mainly given to the image forming apparatus with a communication function in an example of the communication device as a managed device. However, the current invention is not limited to the above preferred embodiments. The current invention is applicable to the following devices with the communication function including a network-based appliance, vending machines, medical devices, power supplies, air conditioning systems, measuring systems for utility such as gas, water and electricity as well as computers that can be connected to the network. Furthermore, the connection format and the components of the communication apparatus, the remote management intermediate apparatus and the management apparatus are not limited to the above described preferred embodiments of the remote management system for the communication devices. The communication between the communication apparatus and the management apparatus includes various lines such as both wire and wireless lines for the network.

The computer software programs implement various functions according to the current invention by executing the programs at the CPU. The various functions are for the communication means, the abnormal information management means, the abnormal condition reporting means and so on. The CPU controls the management apparatus which remotely manages the managed devices over the network. The managed devices include the abnormal condition reporting means for transmitting abnormal information upon detecting its abnormal condition and the abnormal condition removal reporting means for transmitting the abnormal condition removal information upon detecting its abnormal condition removal.

The above described programs are stored in the ROM or HDD of the computer at the installation. Alternatively, the programs are also provided in other non-volatile storage media such as CD-ROM, floppy disks, SRAM and EEPROM. The programs stored in the above memory media are installed in the computer and executed by the CPU to implement the process. Alternatively, the programs are read from the above memory media and executed by the CPU to implement the process. Another alternative is that the programs are downloaded from a peripheral connected to the network and having a storage medium storing the programs or a peripheral having a storing means storing the programs.

What is claimed is:

1. A method of communicating, comprising the steps of:
detecting one of a predetermined set of abnormal conditions at a plurality of managed devices;
transmitting abnormal condition information on the detected abnormal condition from the managed device to the management device;
receiving the abnormal condition information at the management device to store and manage the received abnormal condition information;
detecting removal of the previously detected abnormal condition from a corresponding one of the managed devices, the corresponding managed device defining an originating managed device;
transmitting from the managed device to the management device an abnormal condition removal call corresponding to the previously detected abnormal condition;
receiving the abnormal condition removal call at the management device; and
deleting a corresponding one of the abnormal condition information stored at the management device based upon the received abnormal condition removal call.

2. The method of communicating according to claim 1 wherein the abnormal condition information being distinct for each of the managed devices, the abnormal condition information being stored and managed for each of the managed devices at the management device.

3. The method of communicating according to claim 2 wherein the abnormal condition includes a plurality of abnormal condition types, the abnormal condition removal call being distinct for each of the abnormal condition types.

4. The method of communicating according to claim 1 wherein the abnormal condition removal call indicates the removal of all of the abnormal conditions at a single one of the managed devices.

5. The method of communicating according to claim 1 further comprising an additional step of notifying a center operator of the detected abnormal condition if the corresponding abnormal condition removal call has not been received within a first predetermined amount of time t1 since the reception of the abnormal condition information at the management device.

6. The method of communicating according to claim 1 further comprising additional steps of:
sending a power activation report from the originating managed device to the management device upon temporarily switching off a main power supply of the managed device for subsequent power activation prior to said detecting of the removal of the previously detected abnormal condition from the managed device;
receiving the power activation report at the management device; and
notifying a center operator of the detected abnormal condition if the power activation report has been received within a first predetermined amount of time t1 since the reception of the abnormal condition information at the management device and the corresponding abnormal condition removal call has not been received from the originating managed device within a second predetermined amount of time t2 since the reception of the power activation report at the management device.

7. The method of communicating according to claim 1 further comprising additional steps of:
sending a power activation report from the originating managed device to the management device upon temporarily switching off a main power supply of the managed device for subsequent power activation prior to said detecting of the removal of the previously detected abnormal condition from the managed device;
receiving the power activation report at the management device; and
determining that the previously detected abnormal condition has not been removed by the temporarily switching off of the main power supply of the originating managed device if the corresponding abnormal condition removal call has not been received from the originating managed device within a second predetermined amount of time t2 since the reception of the power activation report at the management device.

8. The method of communicating according to claim 7 wherein if the power activation report has been received within a first predetermined amount of time t1 since the reception of the abnormal condition information at the management device, claim 8 further comprising an additional step of notifying a center operator of the detected abnormal condition.

9. The method of communicating according to any one of claims 5, 6 and 8 further comprising additional steps of:
storing user information for each of the managed devices at the management device; and
determining the first predetermined amount of time t1 based upon the stored user information.

10. The method of communicating according to any one of claims 6 and 8 further comprising additional steps of:
storing device information for each of the managed devices at the management device; and
determining the second predetermined amount of time t2 based upon the stored device information.

11. The method of communicating according to claim 1 wherein the abnormal condition information, the abnormal condition removal call and the power activation report are written in a predetermined structured language.

12. A software program containing computer readable instructions for performing the tasks of communicating, the instructions performing the tasks of:
detecting one of a predetermined set of abnormal conditions at a plurality of managed devices;
transmitting abnormal condition information on the detected abnormal condition from the managed device to the management device;
receiving the abnormal condition information at the management device to store and manage the received abnormal condition information;
detecting removal of the previously detected abnormal condition from a corresponding one of the managed devices, the corresponding managed device defining an originating managed device;
transmitting from the managed device to the management device an abnormal condition removal call corresponding to the previously detected abnormal condition;
receiving the abnormal condition removal call at the management device; and
deleting a corresponding one of the abnormal condition information stored at the management device based upon the received abnormal condition removal call.

13. The software program containing computer readable instructions according to claim 12 wherein the abnormal condition information being distinct for each of the managed devices, the abnormal condition information being stored and managed for each of the managed devices at the management device.

14. The software program containing computer readable instructions according to claim 13 wherein the abnormal condition includes a plurality of abnormal condition types, the abnormal condition removal call being distinct for each of the abnormal condition types.

15. The software program containing computer readable instructions according to claim 12 wherein the abnormal condition removal call indicates the removal of all of the abnormal conditions at a single one of the managed devices.

16. The software program containing computer readable instructions according to claim 12 further comprising an additional task of notifying a center operator of the detected abnormal condition when the corresponding abnormal condition removal call has not been received within a first predetermined amount of time t1 since the reception of the abnormal condition information at the management device.

17. The software program containing computer readable instructions according to claim 12 further comprising additional tasks of:
sending a power activation report from the originating managed device to the management device upon temporarily switching off a main power supply of the managed device for subsequent power activation prior to said detecting of the removal of the previously detected abnormal condition from the managed device;
receiving the power activation report at the management device; and
notifying a center operator of the detected abnormal condition if the power activation report has been received within a first predetermined amount of time t1 since the reception of the abnormal condition information at the management device and the corresponding abnormal condition removal call has not been received from the originating managed device within a second predetermined amount of time t2 since the reception of the power activation report at the management device.

18. The software program containing computer readable instructions according to claim 12 further comprising additional tasks of:
sending a power activation report from the originating managed device to the management device upon temporarily switching off a main power supply of the managed device for subsequent power activation prior to said detecting of the removal of the previously detected abnormal condition from the managed device;
receiving the power activation report at the management device; and
determining that the previously detected abnormal condition has not been removed by the temporarily switching off of the main power supply of the originating managed device if the corresponding abnormal condition removal call has not been received from the originating managed device within a second predetermined amount of time t2 since the reception of the power activation report at the management device.

19. The software program containing computer readable instructions according to claim 18 wherein if the power activation report has been received within a first predetermined amount of time t1 since the reception of the abnormal condition information at the management device, claim 19 further comprising an additional task of notifying a center operator of the detected abnormal condition.

20. The software program containing computer readable instructions according to any one of claims 16, 17 and 19 further comprising additional tasks of:
storing user information for each of the managed devices at the management device; and
determining the first predetermined amount of time t 1 based upon the stored user information.

21. The software program containing computer readable instructions according to any one of claims 17 and 19 further comprising additional tasks of:
storing device information for each of the managed devices at the management device; and
determining the second predetermined amount of time t2 based upon the stored device information.

22. The software program containing computer readable instructions according to claim 12 wherein the abnormal condition information, the abnormal condition removal call and the power activation report are written in a predetermined structured language.

23. A management apparatus for remotely managing a plurality of predetermined managed apparatuses over a computer network, each of the managed apparatuses including an abnormal condition reporting unit for reporting to the management apparatus abnormal condition information on an abnormal condition that is detected in the managed apparatus and a abnormal condition removal reporting unit for reporting to the management apparatus abnormal condition removal information if the detected abnormal condition has been removed in the managed apparatus, a corresponding one of the managed apparatus that is transmitting the abnormal condition removal information defining an originating managed apparatus, comprising:
a communication unit for communicating with the managed apparatuses for receiving the abnormal condition information and the abnormal condition removal information;
an abnormal condition information management unit connected to said communication unit for storing and managing the abnormal condition information that is received from the managed apparatuses; and
an abnormal condition removal determination unit connected to said abnormal condition information management unit and said communication unit for determining whether or not the abnormal condition has been removed from the managed apparatus based upon the abnormal condition removal information.

24. The management apparatus according to claim 23 wherein the abnormal condition information being distinct for each of the managed apparatuses, said abnormal condition information management unit managing the abnormal condition information for each of the managed apparatuses.

25. The management apparatus according to claim 24 wherein the abnormal condition includes a plurality of abnormal condition types, the abnormal condition removal information being distinct for each of the abnormal condition types.

26. The management apparatus according to claim 23 wherein the abnormal condition removal information indicates the removal of all of the abnormal conditions at a single one of the managed apparatuses.

27. The management apparatus according to claim 23 further comprising an abnormal condition notifying unit for notifying a center operator of the detected abnormal condition when the corresponding abnormal condition removal information has not been received within a first predetermined amount of time t1 since the reception of the abnormal condition information at the management apparatus.

28. The management apparatus according to claim 23 wherein said communication unit receives a power activation report at the management apparatus from the originating managed apparatus after a main power supply of the originating managed apparatus had been temporarily switched off for subsequent power activation prior to receiving the abnormal condition removal information, claim 28 further comprising an abnormal condition notifying unit for notifying a center operator of the detected abnormal condition if the power activation report has been received within a first predetermined amount of time t1 since the reception of the abnormal condition information at the management apparatus and the corresponding abnormal condition removal information has not been received from the originating managed apparatus within a second predetermined amount of time t2 since the reception of the power activation report at the management apparatus.

29. The management apparatus according to claim 23 wherein said communication unit receives a power activation report at the management apparatus from the originating managed apparatus after a main power supply of the originating managed apparatus had been temporarily switched off for subsequent power activation prior to receiving the abnormal condition removal information, said abnormal condition removal determination unit determining that the previously detected abnormal condition has not been removed by the temporarily switching off of the main power supply of the originating managed apparatus if the corresponding abnormal condition removal information has not been received from the originating managed apparatus within a second predetermined amount of time t2 since the reception of the power activation report at the management apparatus.

30. The management apparatus according to claim 29 wherein if the power activation report has been received within a first predetermined amount of time t1 since the reception of the abnormal condition information at the management apparatus, claim 30 further comprising an abnormal condition notifying unit for notifying a center operator of the detected abnormal condition.

31. The management apparatus according to any one of claims 27, 28 and 30 further comprising:
a user information storing unit connected to said abnormal condition removal determination unit for storing user information for each of the managed apparatuses, said abnormal condition removal determination unit determining the first predetermined amount of time t1 based upon the stored user information.

32. The management apparatus according to any one of claims 28 and 30 further comprising:
a device information storing unit connected to said abnormal condition removal determination unit for storing device information for each of the managed apparatuses, said abnormal condition removal determination unit determining the second predetermined amount of time t2 based upon the stored device information.

33. The management apparatus according to claim 23 wherein the abnormal condition information, the abnormal condition removal call and the power activation report are written in a predetermined structured language.

34. A remote management system for managing devices over a computer network, comprising:
a plurality of predetermined managed apparatuses, each of the managed apparatuses further comprising:
a first communication unit for communicating with devices;
a detection unit for detecting an abnormal condition within the managed apparatus;
an abnormal condition reporting unit connected to said first communication unit for reporting abnormal condition information on the detected abnormal condition; and
a abnormal condition removal reporting unit connected to said first communication unit for reporting abnormal condition removal information if the detected abnormal condition has been removed in the managed apparatus, a corresponding one of the managed apparatus that is transmitting the abnormal condition removal information defining an originating managed apparatus;
a management apparatus comprising:
a second communication unit for communicating with the managed apparatuses for receiving the abnormal condition information and the abnormal condition removal information;
an abnormal condition information management unit connected to said second communication unit for storing and managing the abnormal condition information that is received from the managed apparatuses; and
an abnormal condition removal determination unit connected to said abnormal condition information management unit and said second communication unit for determining whether or not the abnormal condition has been removed from the managed apparatus based upon the abnormal condition removal information.

35. The remote management system according to claim 34 wherein the abnormal condition information being distinct for each of the managed apparatuses, said abnormal condition information management unit managing the abnormal condition information for each of the managed apparatuses.

36. The remote management system according to claim 35 wherein the abnormal condition includes a plurality of abnormal condition types, the abnormal condition removal information being distinct for each of the abnormal condition types.

37. The remote management system according to claim 34 wherein the abnormal condition removal information indicates the removal of all of the abnormal conditions at a single one of the managed apparatuses.

38. The remote management system according to claim 34 wherein said management apparatus further comprises an abnormal condition notifying unit connected to said abnormal condition removal determination unit for notifying a center operator of the detected abnormal condition when the corresponding abnormal condition removal information has not been received within a first predetermined amount of time t1 since the reception of the abnormal condition information at the management apparatus.

39. The remote management system according to claim 34 wherein said second communication unit receives a power activation report at the management apparatus from the originating managed apparatus after a main power supply of the originating managed apparatus had been temporarily switched off for subsequent power activation prior to receiving the abnormal condition removal information, claim 39 further comprising an abnormal condition notifying unit for notifying a center operator of the detected abnormal condition if the power activation report has been received within a first predetermined amount of time t1 since the reception of the abnormal condition information at the management apparatus and the corresponding abnormal condition removal information has not been received from the originating managed apparatus within a second predetermined amount of time t2 since the reception of the power activation report at the management apparatus.

40. The remote management system according to claim 34 wherein said second communication unit receives a power activation report at the management apparatus from the originating managed apparatus after a main power supply of the originating managed apparatus had been temporarily switched off for subsequent power activation prior to receiving the abnormal condition removal information, said abnormal condition removal determination unit determining that the previously detected abnormal condition has not been removed by the temporarily switching off of the main power supply of the originating managed apparatus if the corresponding abnormal condition removal information has not been received from the originating managed apparatus within a second predetermined amount of time t2 since the reception of the power activation report at the management apparatus.

41. The remote management system according to claim 40 wherein if the power activation report has been received within a first predetermined amount of time t 1 since the reception of the abnormal condition information at the management apparatus, claim 41 further comprising an abnormal condition notifying unit for notifying a center operator of the detected abnormal condition.

42. The remote management system according to any one of claims 38, 39 and 41 wherein said management apparatus further comprises:
a user information storing unit connected to said abnormal condition removal determination unit for storing user information for each of the managed apparatuses, said abnormal condition removal determination unit determining the first predetermined amount of time t1 based upon the stored user information.

43. The remote management system according to any one of claims 39 and 41 wherein said management apparatus further comprises:
a device information storing unit connected to said abnormal condition removal determination unit for storing device information for each of the managed apparatuses, said abnormal condition removal determination unit determining the second predetermined amount of time t2 based upon the stored device information.

44. The remote management system according to claim 34 wherein the abnormal condition information, the abnormal condition removal call and the power activation report are written in a predetermined structured language.
